(19) United States
(12) Patent Application Publication
(10) Pub. No.: US 2021/0072925 A1
(43) Pub. Date: Mar. 11, 2021

(54) COMMUNICATION DEVICE AND COMMUNICATION SYSTEM

(71) Applicant: NEC Platforms, Ltd, Kawasaki-shi, Kanagawa (JP)

(72) Inventor: Kazunori TANOUE, Kanagawa (JP)

(73) Assignee: NEC Platforms, Ltd., Kawasaki-shi, Kanagawa (JP)

(21) Appl. No.: 16/963,664

(22) PCT Filed: Feb. 28, 2019
(86) PCT No.: PCT/JP2019/007810

§ 371 Date: Jul. 21, 2020

(30) Foreign Application Priority Data
Mar. 1, 2018 (JP) 2018-036242

(51) Int. Cl. G06F 3/06

(52) U.S. Cl. CPC G06F 3/0659; G06F 3/0629; G06F 3/067; G06F 3/0613; G06F 3/0653

(57) ABSTRACT

In order to reduce IO processing delay when information transmitted and received between a server and a storage device via a fiber channel line is lost, after receiving, from the transmission source via the fiber channel line, identification information assigned to an information group transmitted by a transmission source, when it is determined, on the basis of the identification information, that at least part of the information group has not been received, the communication device transmits prescribed transmission information to the transmission source via the fiber channel line.

### TECHNICAL FIELD

The present invention relates to a communication system inputting and outputting information.

### BACKGROUND ART

In a storage system performing input-output processing (IO processing) of data between a server and a storage device, processing based on the Fibre Channel (FC) standard (see NPL 1) may be performed in communication for performing the IO processing. Note that IO stands for Input-Output.

FIG. 1 is a conceptual diagram illustrating a configuration of a storage system 401 being a common storage system performing IO processing based on the Fibre Channel standard.

The storage system 401 includes a server 110 and a storage device 210.

The server 110 includes an IO processing unit 112 and a recording unit 113.

The storage device 210 includes an IO processing unit 212, a memory 213, a control unit 216, and a storage unit 214.

For example, the server 110 holds an externally input data frame (hereinafter referred to as “data”) in the recording unit 113. Then, the IO processing unit 112 in the server 110 sends the data held by the recording unit 113 to the IO processing unit 212 in the storage device 210 and causes the storage device 210 to store the data.

Predetermined data are read into the IO processing unit 112 in the server 110 from the IO processing unit 212 in the storage device 210, and the data are stored in the recording unit 113. For example, the stored data are output to the outside of the storage system 401.

Based on the Fibre Channel standard, the IO processing unit 112 in the server 110 performs communication related to the aforementioned IO processing performed with the IO processing unit 212 in the storage device 210 through an FC line 301. FC line stands for Fibre Channel line. The FC line is a line through which information conforming to the Fibre Channel standard may pass.

The IO processing unit 212 in the storage device 210 also performs communication related to the aforementioned IO processing performed with the IO processing unit 112 in the server 110 through the FC line 301, based on the Fibre Channel standard.

For example, the IO processing unit 112 performs the operation described above by processing executed by an unillustrated central processing unit included in the server 110 by use of a program. The IO processing unit 212 in the storage device 210 causes the storage unit 214 to store data sent from the IO processing unit 112 in the server 110 through the memory 213 and the control unit 216. The IO processing unit 212 also reads data to be sent to the IO processing unit 112 in the server 110 from the storage unit 214 through the memory 213 and the control unit 216 and sends the data to the IO processing unit 112.

For example, the IO processing unit 112 performs the operation described above by processing executed by an unillustrated central processing unit included in the storage device 210 by use of a program.

The configuration of the storage system 401 illustrated in FIG. 1 is a configuration employed in a commercially available storage system (for example, see NPL 2). FIG. 2 is a conceptual diagram illustrating an operation performed between the IO processing unit 112 in the server 110 illustrated in FIG. 1 and the IO processing unit 212 in the storage device 210 when the server 110 stores data into the storage device 210. The operation illustrated in FIG. 2 is defined in the Fibre Channel standard.

First, as an operation in A101, the IO processing unit 112 in the server 110 sends a Write command frame (hereinafter referred to as a “Write command”) to the IO processing unit 212 in the storage device 210.

In response to the sending, as an operation in A102, the IO processing unit 212 sends a XferReady frame (hereinafter referred to as “XferReady”) to the IO processing unit 112.

In response to the sending, as operations in A103-1 to A103-N, the IO processing unit 112 sends N pieces of data being first to N-th data to the IO processing unit 212 in the storage device 210. N is a number equal to or greater than one. Each piece of the data is a frame including information to be stored by the storage device 210.

When sending of the N-th data is completed, as an operation in A104, the IO processing unit 212 sends a Response frame (hereinafter referred to as “Response”) to the IO processing unit 112.

FIG. 3 is a conceptual diagram illustrating an operation performed between the IO processing unit 112 in the server 110 and the IO processing unit 212 in the storage device 210 when the server 110 illustrated in FIG. 1 reads data from the storage device 210. The operation illustrated in FIG. 2 is defined in the Fibre Channel standard.

First, as an operation in A201, the IO processing unit 112 in the server 110 sends a Read command to the IO processing unit 212 in the storage device 210.

In response to the sent Read command, as operations in A202-1 to A202-P, the IO processing unit 212 sends first data to P-th data to the IO processing unit 112.

Then, as an operation in A203, the IO processing unit 212 sends Response to the IO processing unit 112.

PTL 1 discloses a DMA device reading data corresponding to a descriptor from a memory.

### CITATION LIST

### Patent Literature

PTL 1: Japanese Unexamined Patent Application Publication No. 2006-195823
PTL 2: Japanese Unexamined Patent Application Publication No. 2010-092336
PTL 3: Japanese Unexamined Patent Application Publication No. 2005-056260

### Non Patent Literature

NPL 1: Wikipedia, The Free Encyclopedia, “Fibre Channel,” [retrieved on Jan. 31, 2018], the Internet (https://ja.wikipedia.org/wiki/% E3%83%95% E3%82% A1% E3%82% A4% E3%83% 90% E3%83% BC % E3%83%81% E3%83% A3% E3%83%8D % E3%83% AB)
NPL 2: [iStorage software M series] software manual, NEC Corporation, [retrieved on Jan. 12, 2018], the Internet (https://support.pf.nec.co.jp/View.aspx?NoClear=on&id=3170100142#ism)

### SUMMARY OF INVENTION

### Technical Problem

Information transmitted and received between the IO processing unit 112 in the server 110 illustrated in FIG. 1 and the IO processing unit 212 in the storage device 210 through the FC line 301 may be lost in the FC line 301 due to an intermittent path failure. At that time, according to the Fibre Channel definition, IO processing related to sending of the information is aborted (timed-out) when a time T being a preset waiting time elapses after the IO processing is started. When the IO processing unit performs the operation described above by a common operating system, the time T is a long time of the order of several tens of seconds. Data storage from the server 110 to the storage device 210 and/or data reading from the storage device 210 by the server 110 is not performed until the time T elapses. Consequently, the data storage from the server 110 to the storage device 210 and/or the data reading from the storage device 210 by the server 110 is delayed by the waiting time.

Consequently, the delay may cause an adverse effect such as a timeout on other processing assuming the data storage and/or reading.

An object of the present invention is to provide a storage system and the like that may reduce a delay in IO processing when information transmitted and received between a server and a storage device through a Fibre Channel line is lost.

### Solution to Problem

A communication device according to the present invention issues predetermined transmission information to a source through a Fibre Channel line when determining that at least part of an information group transmitted by the source is not received, based on identification information assigned to the information group, after receiving the identification information from the source through the Fibre Channel line.

### Advantageous Effects of Invention

The storage system and the like according to the present invention may reduce a delay in IO processing when information transmitted and received between a server and a storage device through a Fibre Channel line is lost.

### BRIEF DESCRIPTION OF DRAWINGS

FIG. 1 is a conceptual diagram illustrating a configuration example of a common storage system performing processing based on the Fibre Channel standard.

FIG. 2 is a conceptual diagram illustrating an IO operation performed between a server and a storage when data are stored into the storage device.

FIG. 3 is a conceptual diagram illustrating an IO operation performed between the server and the storage device when data are read from the storage device.

FIG. 4 is a conceptual diagram illustrating an IO operation example (part 1) between processing units according to a first example embodiment.

FIG. 5 is a conceptual diagram illustrating the IO operation example (part 2) performed between the processing units according to the first example embodiment.

FIG. 6 is a conceptual diagram illustrating the IO operation example (part 3) performed between the processing units according to the first example embodiment.

FIG. 7 is a conceptual diagram illustrating the IO operation example (part 4) performed between the processing units according to the first example embodiment.

FIG. 8 is a conceptual diagram (part 1) illustrating an IO processing flow example performed by the IO processing unit in the server according to the first example embodiment.

FIG. 9 is a conceptual diagram (part 2) illustrating the IO processing flow example performed by the IO processing unit in the server according to the first example embodiment.

FIG. 10 is a conceptual diagram (part 3) illustrating the IO processing flow example performed by the IO processing unit in the server according to the first example embodiment.

FIG. 11 is a conceptual diagram (part 1) illustrating an IO processing flow example performed by the IO processing unit in the storage device according to the first example embodiment.

FIG. 12 is a conceptual diagram (part 2) illustrating the IO processing flow example performed by the IO processing unit in the storage device according to the first example embodiment.

FIG. 13 is a conceptual diagram (part 3) illustrating the IO processing flow example performed by the IO processing unit in the storage device according to the first example embodiment.

FIG. 14 is a conceptual diagram (part 1) illustrating an IO processing flow example performed by an IO processing unit in a server according to a second example embodiment.

FIG. 15 is a conceptual diagram (part 2) illustrating the IO processing flow example performed by the IO processing unit in the server according to the second example embodiment.

FIG. 16 is a conceptual diagram (part 3) illustrating the IO processing flow example performed by the IO processing unit in the server according to the second example embodiment.

FIG. 17 is a conceptual diagram (part 1) illustrating an IO processing flow example performed by an IO processing unit in a storage device according to the second example embodiment.

FIG. 18 is a conceptual diagram (part 2) illustrating the IO processing flow example performed by the IO processing unit in the storage device according to the second example embodiment.

FIG. 19 is a conceptual diagram (part 3) illustrating the IO processing flow example performed by the IO processing unit in the storage device according to the second example embodiment.

FIG. 20 is a block diagram illustrating a minimum configuration of the storage devices according to the example embodiments.

### EXAMPLE EMBODIMENT

### First Example Embodiment

A first example embodiment is an example embodiment related to a storage system performing reception confirmation with respect to information transmitted and received through an FC line.

In the storage system according to the first example embodiment, the transmission side of an FC frame group related to IO processing sends a reception confirmation command to the reception side after transmitting the FC frame group. In response to reception of the reception confirmation command, the reception side makes a determination about whether FC frames included in the FC frame group are received. Then, it is assumed that the reception side determines that one of the FC frames included in the FC frame group is not received. In that case, the reception side sends a reception confirmation response indicating non-reception to the transmission side. The transmission side receiving the reception confirmation response indicating non-reception aborts the IO processing without awaiting a waiting time for timeout described in the Technical Problem section. Then, the transmission side repeats IO processing related to the same data intended to be processed in the IO processing. Thus, the storage system reduces a delay in IO processing when information transmitted and received between a server and a storage device through an FC line is lost, the delay being described in the Technical Problem section.

### Configuration and Operation

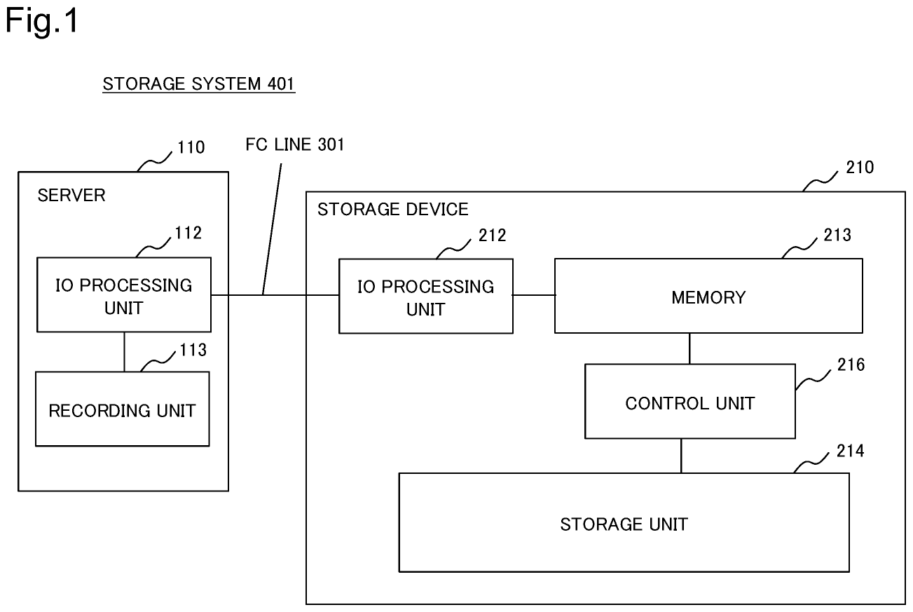

A configuration example of the storage system according to the present example embodiment is the same as the configuration of the storage system 401 illustrated in FIG. 1.

A description of an operation performed by a storage system 401 according to the present example embodiment differs from the description of the operation performed by the storage system 401 described in the Background Art section in the following point.

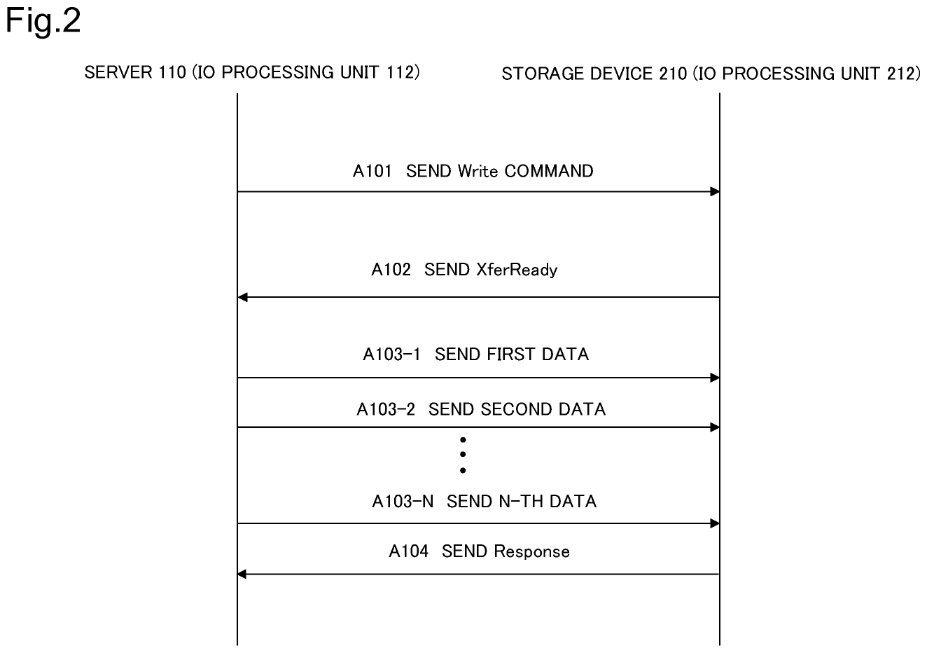

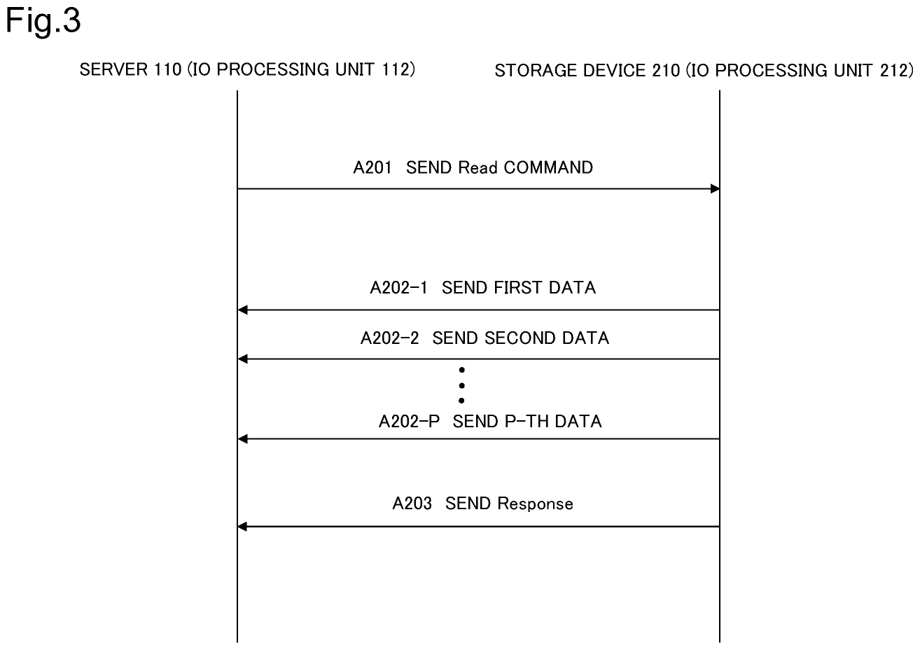

When loss of a Fibre Channel frame (FC frame) occurs due to an intermittent path failure caused in an FC line 301, the storage system 401 aborts IO processing related to the FC frame. An FC frame is a frame conforming to the Fibre Channel standard. An FC frame includes a frame storing each piece of information to be sent as illustrated in FIG. 2 and FIG. 3.

When loss of a sent FC frame occurs in the FC line 301, the storage system 401 aborts IO processing related to the FC frame. Then, the storage system 401 executes the IO processing related to the FC frame again from the beginning.

For example, the storage system 401 performs the operation described above as follows.

In the storage system 401, an IO processing unit being a source of an FC frame (one of the IO processing units 112 and 212) sends a reception confirmation command frame to an IO processing unit being a destination after sending the FC frame to the destination. A reception confirmation command frame is hereinafter referred to as a reception confirmation command.

The reception confirmation command includes an identifier (OX_ID) related to IO processing assigned by the server 110, an identifier (RX_ID) of the IO processing assigned by the storage device 210, and identification information for specifying each transmitted FC frame. The OX_ID and the RX_ID may be identical. A combination of an OX_ID and an RX_ID is hereinafter referred to as an IOID.

The identification information is information allowing identification of whether the FC frame is a Write command, XferReady, data (a data group), Response, or a Read command.

When the FC frame is a data group, the identification information included in the reception confirmation command includes every piece of the identification information indicating data in the data group. For example, with respect to the data described in FIG. 2, the identification information includes information that may allow specification of each piece of the first to N-th data.

The destination determines whether every FC frame related to the identification information is received in IO processing related to the received IOID. When the FC frame being the determination target is a data group, the determination is a determination about whether every piece of data in the data group is received.

When determining that every FC frame related to the identification information is received in the IO processing under execution related to the IOID, the destination sends a reception confirmation response frame (reception confirmation response) including information indicating the reception to the source.

On the other hand, when determining that one of the FC frames related to the identification information is not received, the destination aborts the IO processing related to the IOID. Then, the destination sends, to the source, a reception confirmation response including information indicating that one of the FC frames related to the identification information is not received.

For example, it is assumed that the IO processing unit 112 in the server 110 is on the data transmission side, and the IO processing unit 212 in the storage device 210 is on the data reception side. In that case, after transmitting every piece of data to be sent to the storage device 210 in IO processing related to a predetermined IOID to the IO processing unit 212 on the reception side, the IO processing unit 112 on the transmission side sends a reception confirmation command to the IO processing unit 212. Then, when a reception confirmation response to the reception confirmation command indicates that one piece of sent data is not received, the IO processing unit 112 promptly aborts the IO processing related to the IOID. Then, the IO processing unit 112 executes the IO processing related to the IOID again from the beginning.

In this case, based on the reception confirmation response, the IO processing unit 112 in the server 110 learns whether the IO processing unit 212 in the storage device 210 receives data. Then, by the reception confirmation response, the IO processing unit 112 may promptly detect FC frame loss caused by a path failure in the FC line 301 illustrated in FIG. 1. Then, the IO processing unit 112 executes IO processing related to the same data as previously sent data again from the beginning.

On the other hand, the IO processing unit 212 sending the reception confirmation response to the IO processing unit 112 also aborts the IO processing related to the IOID.

Consequently, the IO processing unit 112 can promptly re-execute aborted IO processing independent of a retry sequence being a re-execution procedure related to abortion of regular IO processing defined by Fibre Channel. Accordingly, the storage system 401 can omit a waiting time for timeout required in a case of IO processing abortion from the server 110 to the storage device 210 after detecting an IO processing timeout, the waiting time being defined in the retry sequence.

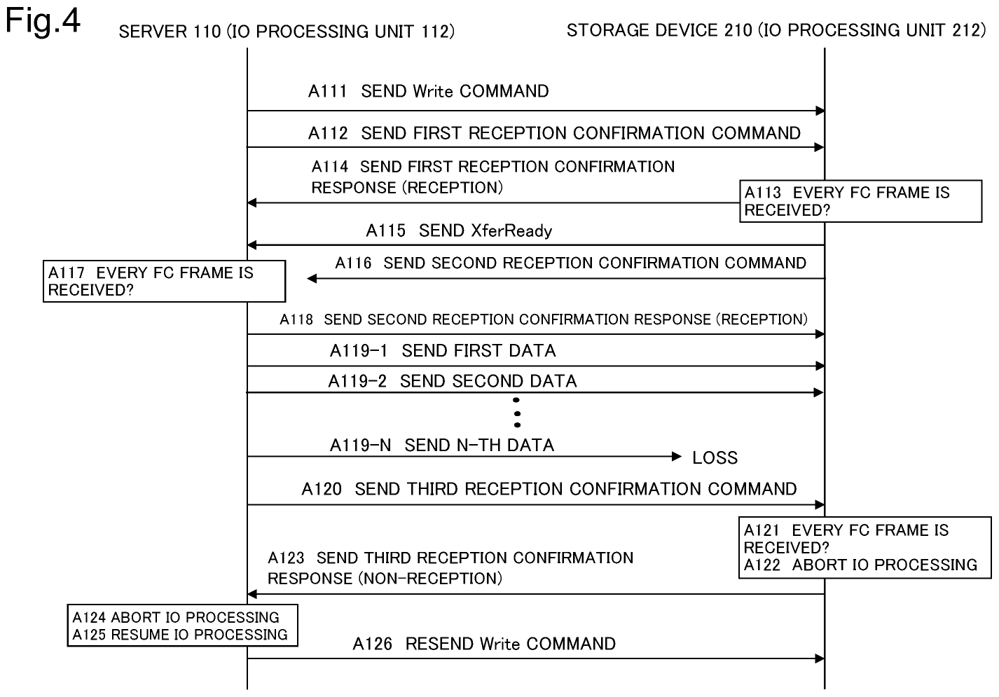

Various FC frames defined by Fibre Channel may be assumed as FC frames that may be lost in the FC line 301. Operation examples related to IO processing performed between the IO processing unit 112 in the server 110 and the IO processing unit 212 in the storage device 210 will be described below with reference to FIG. 4 to FIG. 7 according to a type of a lost frame.

FIG. 4 is a conceptual diagram illustrating an IO operation example performed between the IO processing unit 112 and the IO processing unit 212 when a lost frame is N-th data to be stored into the storage device 210 by the server 110.

First, as an operation in A111, the IO processing unit 112 in the server 110 sends a Write command to the IO processing unit 212 in the storage device 210.

Then, as processing in A112, the IO processing unit 212 in the storage device 210 sends a first reception confirmation command to the IO processing unit 212. The first reception confirmation command includes identification information indicating the Write command.

In response to the received first reception confirmation command, as an operation in A113, the IO processing unit 212 makes a determination about whether every FC frame related to the identification information included in the first reception confirmation command is received. In this case, the IO processing unit 212 receives the Write command indicated by the identification information included in the first reception confirmation command, in the operation in A111. Consequently, the IO processing unit 212 determines that every FC frame related to the identification information included in the first reception confirmation command is received, by the operation in A113. Consequently, the IO processing unit 212 does not abort the IO processing under execution related to an IOID included in the first reception confirmation command and continues the IO processing.

Then, as an operation in A114, the IO processing unit 212 sends, to the IO processing unit 112, a first reception confirmation response indicating that every FC frame related to the identification information included in the first reception confirmation command is received.

Then, as an operation in A115, the IO processing unit 212 sends XferReady to the IO processing unit 112.

Then, as an operation in A116, the IO processing unit 212 sends a second reception confirmation command to the IO processing unit 112. The second reception confirmation command includes identification information of XferReady.

In response to the sending of the second reception confirmation command, as an operation in A117, the IO processing unit 112 makes a determination about whether every FC frame related to the identification information included in the sent second reception confirmation command is received. In this case, the IO processing unit 112 receives XferReady indicated by the identification information included in the second reception confirmation command. Consequently, the IO processing unit 112 determines that every FC frame related to the identification information included in the second reception confirmation command is received. Consequently, the IO processing unit 112 does not abort the IO processing under execution related to an IOID included in the second reception confirmation command and continues the processing.

Then, as an operation in A118, the IO processing unit 112 sends a second reception confirmation response indicating that every FC frame related to the identification information included in the second reception confirmation command is received to the IO processing unit 212. The IO processing unit 212 receiving the second reception confirmation response does not abort the IO processing under execution related to the IOID included in the second reception confirmation command and continues the processing.

Then, as operations in A119-1 to A119-N, the IO processing unit 112 sends first to N-th data to the IO processing unit 212. It is assumed that the N-th data out of the first to N-th data are lost in the FC line 301 illustrated in FIG. 1.

Regardless of the loss, as an operation in A120, the IO processing unit 112 sends a third reception confirmation command to the IO processing unit 212. The third reception confirmation command includes identification information indicating each piece of the first to N-th data sent by the operations in A119-1 to A119-N.

In response to the sending of the third reception confirmation command, as an operation in A121, the IO processing unit 212 makes a determination about whether every FC frame related to identification information included in the third reception confirmation command is received. The IO processing unit 212 does not receive the lost N-th data. Consequently, based on the determination, the IO processing unit 212 derives a determination result that one piece of data is not received.

Then, as an operation in A122, the IO processing unit 212 aborts the IO processing under execution related to an IOID included in the third reception confirmation command.

Then, as an operation in A123, the IO processing unit 212 sends, to the IO processing unit 112, a third reception confirmation response including information indicating that one piece of data is not received.

In response to the reception of the third reception confirmation response, as an operation in A124, the IO processing unit 112 aborts the IO processing under execution related to the IOID included in the third reception confirmation command.

Then, as an operation in A125, the IO processing unit 112 executes JO processing related to sending the first to N-th data included in the same data group intended to be sent in the aborted IO processing again from the beginning.

Then, as an operation in A126, the IO processing unit 112 resends a Write command related to the resumed IO processing to the IO processing unit 212.

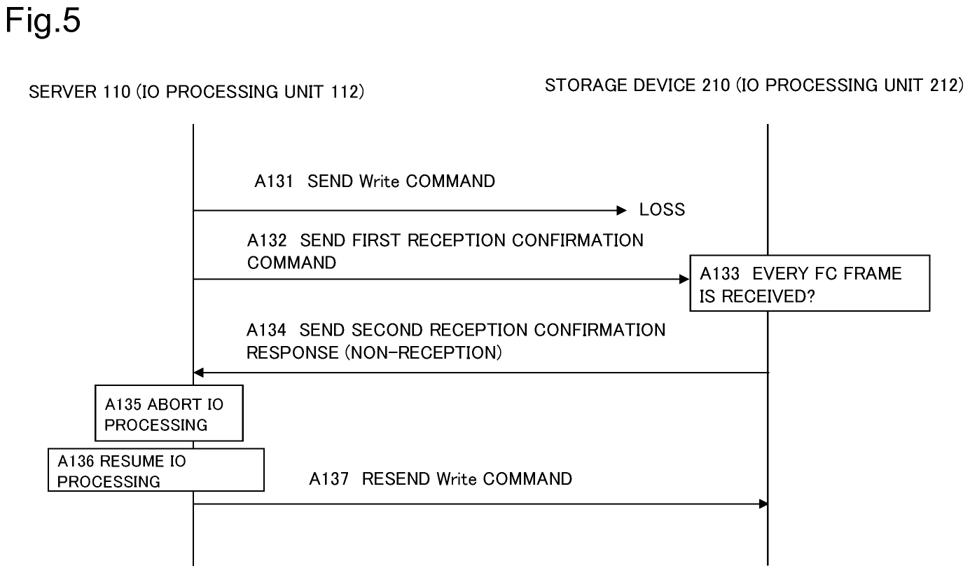

FIG. 5 is a conceptual diagram illustrating an JO operation example performed between the IO processing unit 112 and the IO processing unit 212 when a lost frame is a Write command sent to the storage device 210 by the server 110.

First, as an operation in A131, the IO processing unit 112 sends a Write command to the IO processing unit 212. It is assumed that the Write command is lost in the FC line 301 illustrated in FIG. 1.

Regardless of the loss, as an operation in A132, the IO processing unit 112 sends a first reception confirmation command to the IO processing unit 212. The first reception confirmation command includes identification information indicating the Write command.

In response to the sending of the first reception confirmation command, the IO processing unit 212 performs an operation in A133. The operation in A133 is determination of whether every FC frame related to the identification information included in the first reception confirmation command is received in the IO processing under execution. The IO processing unit 212 does not receive the lost Write command. Consequently, by the operation in A133, the JO processing unit 212 determines that an FC frame related to one piece of the identification information included in the first reception confirmation command is not received.

Then, as an operation in A134, the IO processing unit 212 sends, to the IO processing unit 112, a first reception confirmation response including information indicating that an FC frame related to one piece of the identification information included in the first reception confirmation command is not received.

In response to the sending of the first reception confirmation response, as an operation in A135, the IO processing unit 112 aborts the IO processing under execution related to an IOID included in the first reception confirmation command.

Then, as an operation in A136, the IO processing unit 112 executes IO processing related to the same data (data group) intended to be processed in the aborted IO processing again from the beginning.

Then, as an operation in A137, the IO processing unit 112 resends the Write command in the IO processing to the IO processing unit 212.

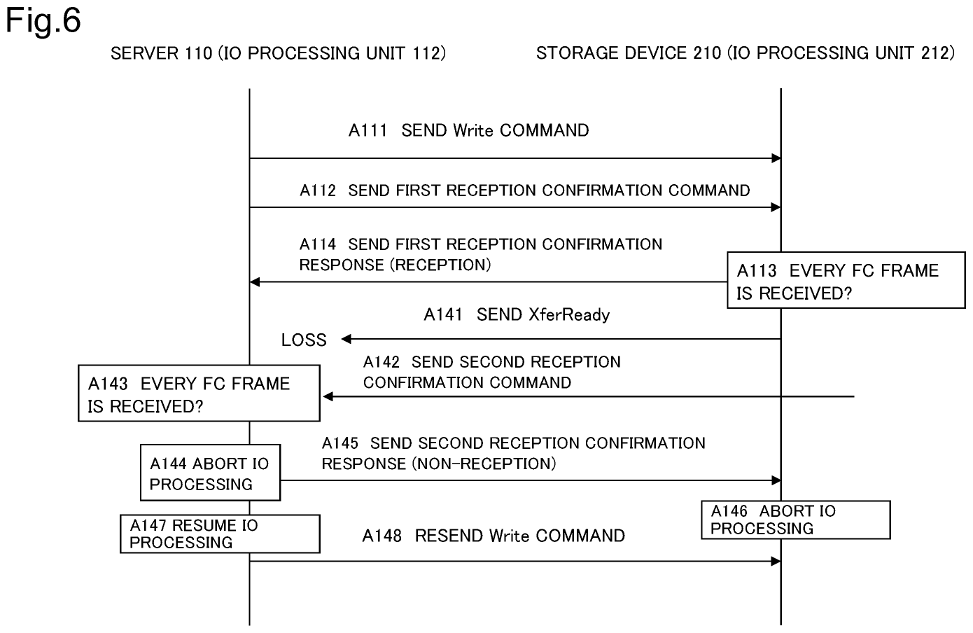

FIG. 6 is a conceptual diagram illustrating an IO operation example performed between the IO processing unit 112 and the IO processing unit 212 when a lost frame is an XferReady command sent to the server 110 by the storage device 210.

A description of operations in A111 to A113 described in FIG. 6 is the same as the description of the operations in A111 to A113 described in FIG. 4. Accordingly, description thereof is omitted.

Subsequently to the operation in A113, as an operation in A141, the IO processing unit 212 sends XferReady to the IO processing unit 112. It is assumed that this XferReady is lost in the FC line 301 illustrated in FIG. 1.

Regardless of the loss, as an operation in A142, the IO processing unit 212 sends a second reception confirmation command to the IO processing unit 112. The second reception confirmation command includes identification information indicating XferReady.

In response to the sending of the second reception confirmation command, the IO processing unit 112 performs an operation in A143. The operation in A143 is determination of whether every FC frame indicated by the identification information included in the second reception confirmation command is received in the IO processing under execution. XferReady sent by the IO processing unit 212 by the operation in A141 is lost. Consequently, the IO processing unit 112 does not receive XferReady. Then, based on the determination, the 10 processing unit 112 derives a determination result indicating that an FC frame related to one piece of the identification information is not received.

Then, as an operation in A144, the IO processing unit 112 aborts the IO processing under execution related to an IOID included in the second reception confirmation command.

Then, as an operation in A145, the IO processing unit 112 sends, to the IO processing unit 212, a second reception confirmation response including information indicating that an FC frame related to one piece of the identification information is not received.

Based on the sent second reception confirmation response, as an operation in A146, the IO processing unit 212 aborts the IO processing under execution related to the IOID included in the second reception confirmation command.

Subsequently, as an operation in A147, the IO processing unit 112 executes IO processing related to sending of the same data (data group) intended to be sent in the aborted IO processing again from the beginning.

Then, as an operation in A148, the IO processing unit 112 sends a Write command related to the started IO processing to the IO processing unit 212.

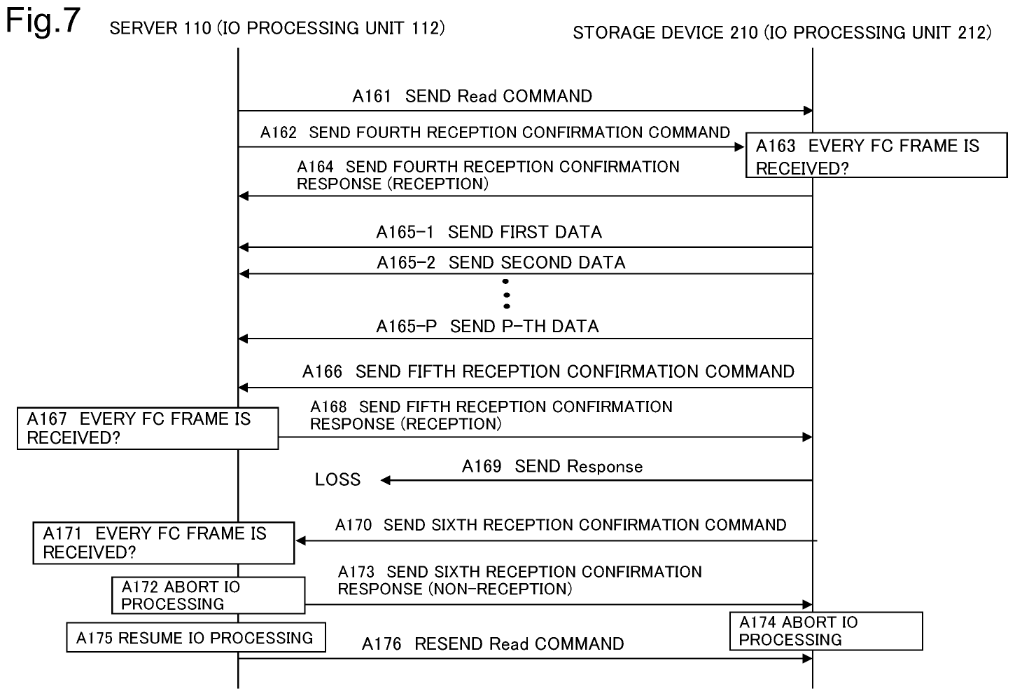

FIG. 7 is a conceptual diagram illustrating an operation example related to communication processing performed between the IO processing unit 112 and the IO processing unit 212 when a lost frame is Response sent to the server 110 by the storage device 210.

First, as an operation in A161, the IO processing unit 112 in the server 110 sends a Read command to the IO processing unit 212 in the storage device 210.

Then, as an operation in A162, the IO processing unit 112 sends a fourth reception confirmation command to the IO processing unit 212. The fourth reception confirmation command includes identification information indicating the Read command.

In response to the sending of the fourth reception confirmation command, the IO processing unit 212 performs an operation in A163. The operation in A163 is making a determination about whether every FC frame related to the identification information included in the fourth reception confirmation command is received. The IO processing unit 212 receives the Read command by the operation in A161. Consequently, the IO processing unit 212 determines that every FC frame related to the identification information included in the fourth reception confirmation command is received by the IO processing under execution related to an IOID included in the fourth reception confirmation command. Consequently, the IO processing unit 212 does not abort the JO processing under execution related to the IOID included in the fourth reception confirmation command and continues the processing.

Then, as an operation in A164, the IO processing unit 212 sends, to the JO processing unit 112, a fourth reception confirmation response including information indicating that every FC frame related to the identification information included in the fourth reception confirmation command is received.

Then, as operations in A165-1 to A165-P, the IO processing unit 212 sends first to P-th data to the IO processing unit 112. It is assumed that P pieces of data are sent in the IO processing under execution.

Next, as an operation in A166, the IO processing unit 212 sends a fifth reception confirmation command to the IO processing unit 112. The fifth reception confirmation command includes identification information indicating the first to P-th data.

In response to the sending of the fifth reception confirmation command, as an operation in A137, the IO processing unit 112 makes a determination about whether every FC frame related to the identification information included in the fifth reception confirmation command is received by the IO processing under execution. In this case, the IO processing unit 112 receives every piece of the first to P-th data. Consequently, the IO processing unit 112 determines that every FC frame related to the identification information included in the fifth reception confirmation command is received by the IO processing under execution. Consequently, the IO processing unit 112 does not abort the IO processing under execution related to an IOID included in the fifth reception confirmation command and continues the processing.

Then, as an operation in A168, the IO processing unit 112 sends a fifth reception confirmation response including information that every FC frame related to the identification information included in the fifth reception confirmation command is received by the IO processing under execution to the IO processing unit 212. The IO processing under execution is related to the IOID included in the fifth reception confirmation command.

In response to the sending of the fifth reception confirmation response, the IO processing unit 212 does not abort the IO processing under execution related to the IOID included in the fifth reception confirmation command and continues the processing.

Then, as an operation in A169, the IO processing unit 212 sends Response to the IO processing unit 112. It is assumed that this Response is lost in the FC line 301 illustrated in FIG. 1.

Regardless of the loss, as an operation in A170, the IO processing unit 212 sends a sixth reception confirmation command related to reception confirmation of Response. The sixth reception confirmation command includes identification information indicating Response.

In response to the sending of the sixth reception confirmation command, as an operation in A171, the IO processing unit 112 makes a determination about whether every FC frame related to the identification information included in the sixth reception confirmation command is received by the IO processing under execution. In this case, the IO processing unit 112 does not receive Response. Consequently, the IO processing unit 112 determines that one of the FC frames related to the identification information included in the sixth reception confirmation command is not received by the IO processing under execution related to an IOID included in the sixth reception confirmation command.

Consequently, as an operation in A172, the IO processing unit 112 aborts the IO processing under execution related to the IOID included in the sixth reception confirmation command.

Then, as an operation in A173, the IO processing unit 112 sends, to the IO processing unit 212, a sixth reception confirmation response indicating that one of the FC frames related to the identification information included in the sixth reception confirmation command is not received.

In response to the sending of the sixth reception confirmation response, as an operation in A174, the IO processing unit 212 aborts the IO processing under execution related to the IOID included in the sixth reception confirmation command.

Subsequently, as an operation in A175, the IO processing unit 112 starts IO processing targeting reading related to the first to P-th data from the storage device 210 again, the reading being targeted by the aborted IO processing.

Then, as an operation in A176, the IO processing unit 112 resends the Read command related to the IO processing to the IO processing unit 212.

### Processing Flow Example

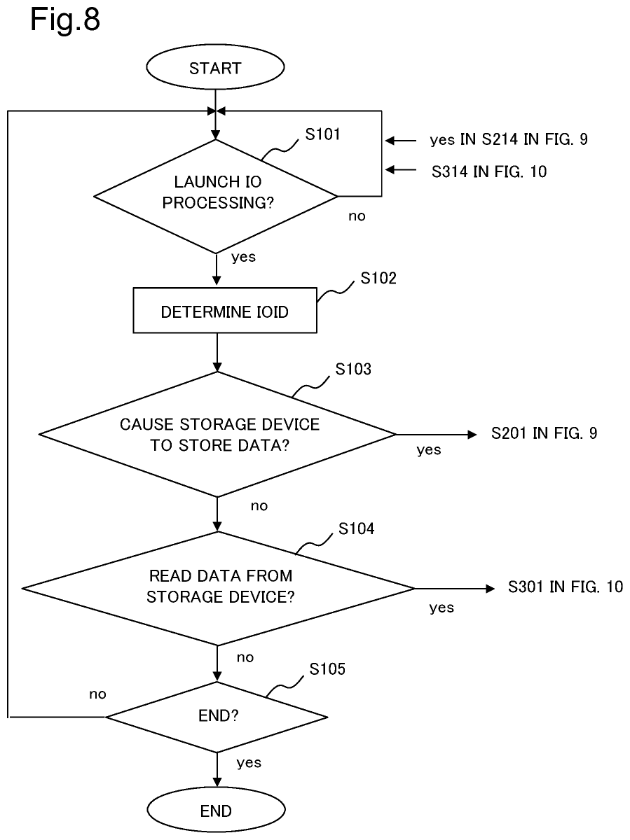

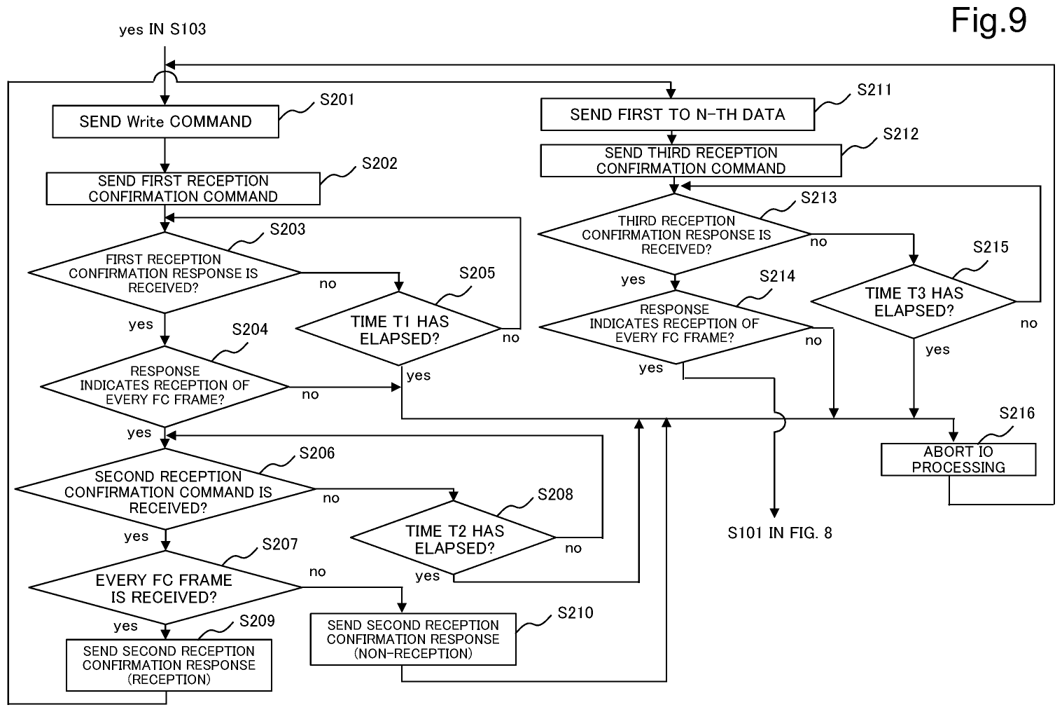

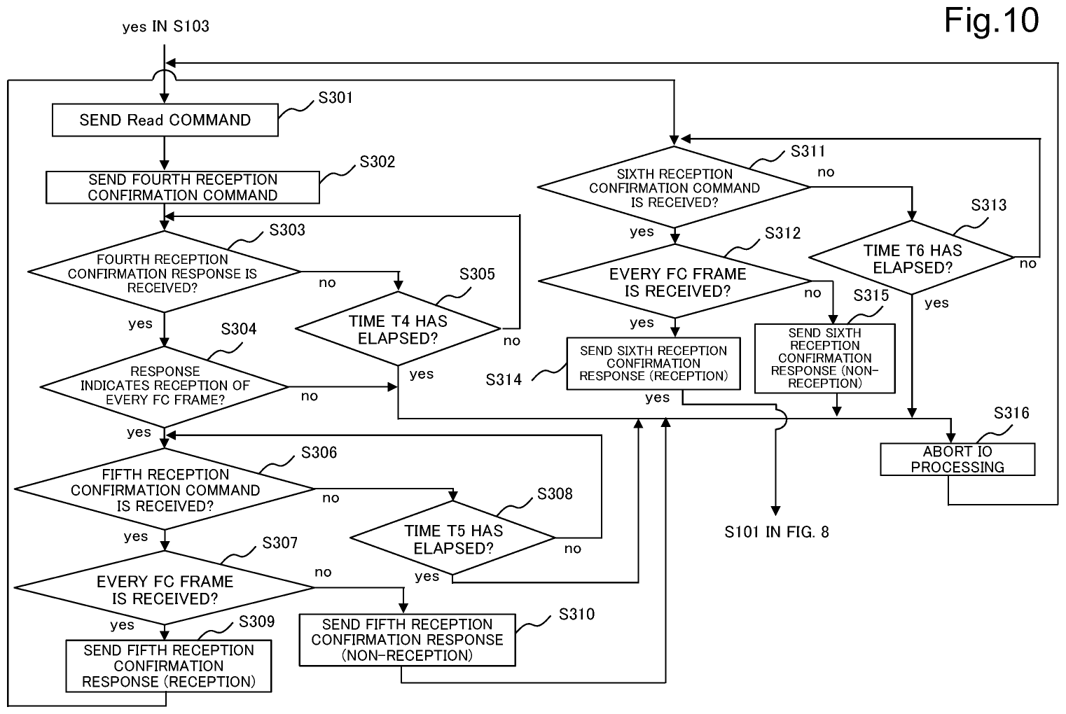

FIG. 8 to FIG. 10 are conceptual diagrams illustrating a processing flow example of processing performed by the IO processing unit 112 in the server 110 illustrated in FIG. 1.

For example, the IO processing unit 112 starts the processing illustrated in FIG. 8 in response to external input of start information.

Then, as processing in S101, the IO processing unit 112 makes a determination about whether to launch predetermined IO processing. For example, the IO processing unit 112 makes the determination in accordance with instruction information input from a control unit being included in the server 110 and not being illustrated in FIG. 1.

When the determination result by the processing in S101 is yes, the IO processing unit 112 performs processing in S102.

On the other hand, when the determination result by the processing in S101 is no, the IO processing unit 112 performs the processing in S101 again.

When performing the processing in S102, the IO processing unit 112 determines an IOID related to the IO processing to be launched, as the processing. At that time, for example, the IO processing unit 112 adds 1 to the aforementioned OX_ID included in the IOID determined by the immediately preceding processing in S102 and sets the resulting IOID as an IOID to be determined by the processing in S102 this time.

Then, as processing in S103, the IO processing unit 112 makes a determination about whether the IO processing the IOID of which being determined by the processing in S102 causes the storage device 210 to store predetermined data. For example, the IO processing unit 112 makes the determination in accordance with instruction information input from the control unit.

When the determination result by the processing in S103 is yes, the 10 processing unit 112 performs processing in S201 described in FIG. 9.

On the other hand, when the determination result by the processing in S103 is no, the IO processing unit 112 performs processing in S104.

When performing the processing in S104, the IO processing unit 112 makes a determination about whether the IO processing the IOID of which being determined by the processing in S102 reads data from the storage device 210, as the processing. For example, the IO processing unit 112 makes the determination in accordance with instruction information input from the control unit.

When the determination result by the processing in S104 is yes, the 10 processing unit 112 performs processing in S301 described in FIG. 10.

On the other hand, when the determination result by the processing in S104 is no, the IO processing unit 112 performs processing in S105.

When performing the processing in S105, the IO processing unit 112 makes a determination about whether to end the processing illustrated in FIG. 8 to FIG. 10, as the processing. For example, the IO processing unit 112 makes the determination by determining whether external input of end information exists.

When the determination result by the processing in S105 is yes, the IO processing unit 112 ends the processing illustrated in FIG. 8 to FIG. 10.

On the other hand, when the determination result by the processing in S105 is no, the IO processing unit 112 performs the processing in S101 again.

When performing the processing in S201 described in FIG. 9, the IO processing unit 112 sends a Write command to the IO processing unit 212 in the storage device 210, as the processing. The Write command includes the aforementioned IOID. The processing corresponds to the operation in A111 described in FIG. 4.

Then, as the processing in S201, the IO processing unit 112 sends a first reception confirmation command to the IO processing unit 212. The first reception confirmation command includes identification information indicating the Write command, and the IOID. The processing corresponds to the operation in A112 described in FIG. 4.

Then, as processing in S203, the IO processing unit 112 makes a determination about whether sending of a first reception confirmation response including the IOID is received from the IO processing unit 212 in response to the processing in S202.

When the determination result by the processing in S203 is yes, the IO processing unit 112 performs processing in S204.

On the other hand, when the determination result by the processing in S203 is no, the IO processing unit 112 performs processing in S205.

When performing the processing in S205, the IO processing unit 112 makes a determination about whether a time T1 has elapsed after the processing in S202 is ended, as the processing. The time T1 is a predetermined time for indicating an upper limit of a time in which the processing in S203 is repeated. It is assumed that the IO processing unit 112 is in an environment where a timer can be used.

The time T1 is a remarkably short time (for example, of the order of several hundreds of milliseconds) compared with a waiting time for timeout (of the order of several tens of seconds) in the storage system described in the Technical Problem section and the Background Art section.

When the determination result by the processing in S205 is yes, the IO processing unit 112 performs processing in S216.

On the other hand, when the determination result by the processing in S205 is no, the IO processing unit 112 performs the processing in S203 again.

When performing the processing in S204, the IO processing unit 112 makes a determination about whether the first reception confirmation response indicates that every FC frame related to the identification information included in the first reception confirmation command sent by the processing in S202 is received, as the processing.

When the determination result by the processing in S204 is yes, the IO processing unit 112 performs processing in S206.

On the other hand, when the determination result by the processing in S204 is no, the IO processing unit 112 performs the processing in S216.

When performing the processing in S206, the IO processing unit 112 makes a determination about whether a second reception confirmation command including an IOID included in the Write command sent by the processing in S201 is received, as the processing. The second reception confirmation command includes identification information of XferReady.

When the determination result by the processing in S206 is yes, the IO processing unit 112 performs processing in S207.

On the other hand, when the determination result by the processing in S206 is no, the IO processing unit 112 performs processing in S208.

When performing the processing in S208, the IO processing unit 112 makes a determination about whether a time T2 has elapsed after yes is determined in the most recent processing in S204, as the processing. The time T2 is a predetermined time for indicating an upper limit of a time in which the processing in S206 is repeated.

The time T2 is a remarkably short time (for example, of the order of several hundreds of milliseconds) compared with the aforementioned waiting time for timeout (of the order of several tens of seconds).

When the determination result by the processing in S208 is yes, the IO processing unit 112 performs the processing in S216.

On the other hand, when the determination result by the processing in S208 is no, the IO processing unit 112 performs the processing in S206 again.

When performing the processing in S207, the IO processing unit 112 makes a determination about whether every FC frame related to the identification information included in the second reception confirmation command reception of which being determined by the processing in S206 is received, as the processing. The identification information included in the second reception confirmation command is the identification information of XferReady. Accordingly, the determination is a determination about whether XferReady is received. The processing in S207 corresponds to the operation in A117 described in FIG. 4.

When the determination result by the processing in S207 is yes, the IO processing unit 112 performs processing in S209.

On the other hand, when the determination result by the processing in S207 is no, the IO processing unit 112 performs processing in S210.

When performing the processing in S209, the IO processing unit 112 sends, to the IO processing unit 212, a second reception confirmation response indicating that every FC frame included in the second reception confirmation command reception of which being determined is received by the processing in S208, as the processing. The processing in S209 corresponds to the operation in A118 described in FIG. 4. Then, the IO processing unit 112 performs processing in S211.

When performing the processing in S210, the IO processing unit 112 sends, to the IO processing unit 212, a second reception confirmation response indicating that one of the FC frames included in the second reception confirmation command reception of which being determined by the processing in S208 is not received, as the processing. Then, the IO processing unit 112 performs the processing in S216.

When performing the processing in S211, the IO processing unit 112 sends N pieces of data being first to N-th data to the IO processing unit 212, as the processing. The processing in S211 corresponds to the operations in A119-1 to A119-N described in FIG. 4.

Then, as processing in S212, the IO processing unit 112 sends a third reception confirmation command to the IO processing unit 212. The third reception confirmation command includes an IOID included in the Write command sent by the most recent processing in S201 and identification information indicating the first to N-th data. The processing in S212 corresponds to the operation in A120 described in FIG. 4.

Then, as processing in S213, the IO processing unit 112 makes a determination about whether a third reception confirmation response being a response to the third reception confirmation command sent by the processing in S212 is received.

When the determination result by the processing in S213 is yes, the IO processing unit 112 performs processing in S214.

On the other hand, when the determination result by the processing in S213 is no, the IO processing unit 112 performs processing in S215.

When performing the processing in S215, the IO processing unit 112 makes a determination about whether a time T3 has elapsed after the most recent processing in S212 is ended, as the processing. The time T3 is a predetermined time for indicating an upper limit of a time in which the processing in S213 is repeated.

The time T3 is a remarkably short time (for example, of the order of several hundreds of milliseconds) compared with the aforementioned waiting time for timeout (of the order of several tens of seconds).

When the determination result by the processing in S215 is yes, the IO processing unit 112 performs the processing in S216.

On the other hand, when the determination result by the processing in S215 is no, the IO processing unit 112 performs the processing in S213 again.

When performing the processing in S214, the IO processing unit 112 makes a determination about whether the third reception confirmation response indicates that every FC frame related to the identification information included in the third reception confirmation command sent by the processing in S212 is received, as the processing.

When the determination result by the processing in S214 is yes, the IO processing unit 112 performs the processing in S101 described in FIG. 8 again.

On the other hand, when the determination result by the processing in S214 is no, the IO processing unit 112 performs the processing in S216.

When performing the processing in S216, the IO processing unit 112 aborts IO processing related to the IOID determined by the most recent processing in S102 described in FIG. 8, as the processing. The processing in S216 includes processing corresponding to the operation in A124 described in FIG. 4.

Then, the IO processing unit 112 performs the processing in S201 again.

When performing the processing in S301 described in FIG. 10, the IO processing unit 112 sends a Read command to the IO processing unit 212, as the processing. The Read command includes the IOID determined by the processing in S102 described in FIG. 8. The processing in S301 corresponds to the operation in A161 described in FIG. 7.

Then, as processing in S302, the IO processing unit 112 sends a fourth reception confirmation command to the IO processing unit 212. The fourth reception confirmation command includes the IOID included in the Read command and identification information of the Read command. The processing in S302 corresponds to the operation in A162 described in FIG. 7.

Then, as processing in S303, the IO processing unit 112 makes a determination about whether a fourth reception confirmation response being a response to the fourth reception confirmation command sent by the processing in S302 is received.

When the determination result by the processing in S303 is yes, the IO processing unit 112 performs processing in S304.

On the other hand, when the determination result by the processing in S303 is no, the IO processing unit 112 performs processing in S305.

When performing the processing in S305, the IO processing unit 112 makes a determination about whether a time T4 has elapsed after the most recent processing in S302 is ended, as the processing. The time T4 is a predetermined time for indicating an upper limit of a time in which the processing in S303 is repeated.

The time T4 is a remarkably short time (for example, of the order of several hundreds of milliseconds) compared with the aforementioned waiting time for timeout (of the order of several tens of seconds).

When the determination result by the processing in S305 is yes, the IO processing unit 112 performs processing in S316.

On the other hand, when the determination result by the processing in S305 is no, the IO processing unit 112 performs the processing in S303 again.

When performing the processing in S304, the IO processing unit 112 makes a determination about whether the fourth reception confirmation response indicates that every FC frame related to the identification information included in the fourth reception confirmation command sent by the processing in S302 is received, as the processing.

When the determination result by the processing in S304 is yes, the IO processing unit 112 performs processing in S306.

On the other hand, when the determination result by the processing in S304 is no, the IO processing unit 112 performs the processing in S316.

When performing the processing in S306, the IO processing unit 112 makes a determination about whether a fifth reception confirmation command including the same IOID as the IOID included in the Write command sent by the processing in S301 is received, as the processing. The fifth reception confirmation command includes identification information of first to P-th data.

When the determination result by the processing in S306 is yes, the IO processing unit 112 performs processing in S307.

On the other hand, when the determination result by the processing in S306 is no, the IO processing unit 112 performs processing in S308.

When performing the processing in S308, the IO processing unit 112 makes a determination about whether a time T5 has elapsed after yes is determined in the most recent processing in S304, as the processing. The time T5 is a predetermined time for indicating an upper limit of a time in which the processing in S306 is repeated.

The time T5 is a remarkably short time (for example, of the order of several hundreds of milliseconds) compared with the aforementioned waiting time for timeout (of the order of several tens of seconds).

When the determination result by the processing in S308 is yes, the IO processing unit 112 performs the processing in S316.

On the other hand, when the determination result by the processing in S308 is no, the IO processing unit 112 performs the processing in S306 again.

When performing the processing in S307, the IO processing unit 112 makes a determination about whether every FC frame indicated by the identification information included in the fifth reception confirmation command reception of which being determined by the processing in S306 is received, as the processing. The identification information included in the fifth reception confirmation command is identification information of the first to P-th data. Accordingly, the determination is a determination about whether every piece of the first to P-th data is received. The processing in S307 corresponds to the operation in A167 described in FIG. 7.

When the determination result by the processing in S307 is yes, the IO processing unit 112 performs processing in S309.

On the other hand, when the determination result by the processing in S307 is no, the IO processing unit 112 performs processing in S310.

When performing the processing in S309, the IO processing unit 112 sends, to the IO processing unit 212, a fifth reception confirmation response indicating that every FC frame included in the fifth reception confirmation command reception of which being determined by the processing in S307 is received, as the processing. The processing in S309 corresponds to the operation in A168 described in FIG. 7. Then, the IO processing unit 112 performs processing in S311.

When performing the processing in S310, the IO processing unit 112 sends, to the IO processing unit 212, a fifth reception confirmation response indicating that one of the FC frames included in the fifth reception confirmation command reception of which being determined by the processing in S307 is not received, as the processing. Then, the IO processing unit 112 performs the processing in S316.

When performing the processing in S311, the IO processing unit 112 makes a determination about whether a sixth reception confirmation command is received, as the processing. The sixth reception confirmation command includes an IOID included in the Read command sent by the most recent processing in S301 and identification information indicating Response.

When the determination result by the processing in S311 is yes, the IO processing unit 112 performs processing in S312.

On the other hand, when the determination result by the processing in S311 is no, the IO processing unit 112 performs processing in S313.

When performing the processing in S313, the IO processing unit 112 makes a determination about whether a time T6 has elapsed after the most recent processing in S309 is ended, as the processing. The time T6 is a predetermined time for indicating an upper limit of a time in which the processing in S311 is repeated.

The time T6 is a remarkably short time (for example, of the order of several hundreds of milliseconds) compared with the aforementioned waiting time for timeout (of the order of several tens of seconds).

When the determination result by the processing in S313 is yes, the IO processing unit 112 performs the processing in S316.

On the other hand, when the determination result by the processing in S313 is no, the IO processing unit 112 performs the processing in S311 again.

When performing the processing in S312, the IO processing unit 112 makes a determination about whether every FC frame related to the identification information included in the sixth reception confirmation command reception of which being determined by the processing in S311 is received, as the processing. The identification information included in the sixth reception confirmation command indicates Response. Accordingly, the IO processing unit 112 makes a determination about whether Response is received, as the processing. The processing in S312 corresponds to the operation in A171 described in FIG. 7.

When the determination result by the processing in S312 is yes, the IO processing unit 112 performs processing in S314.

On the other hand, when the determination result by the processing in S312 is no, the IO processing unit 112 performs processing in S315.

When performing the processing in S314, the IO processing unit 112 sends, to the IO processing unit 212, a sixth reception confirmation response including information indicating that every FC frame related to the identification information included in the sixth reception confirmation command is received, as the processing.

Then, the IO processing unit 112 performs the processing in S101 described in FIG. 8 again.

When performing the processing in S315, the IO processing unit 112 sends, to the IO processing unit 212, a sixth reception confirmation response including information indicating that one of the FC frames related to the identification information included in the sixth reception confirmation command is not received, as the processing.

Then, the IO processing unit 112 performs the processing in S316.

When performing the processing in S316, the IO processing unit 112 aborts IO processing related to the IOID determined by the most recent processing in S102 described in FIG. 8, as the processing. The processing in S316 includes processing corresponding to the operation in A172 described in FIG. 7.

Then, the IO processing unit 112 performs the processing in S301 again.

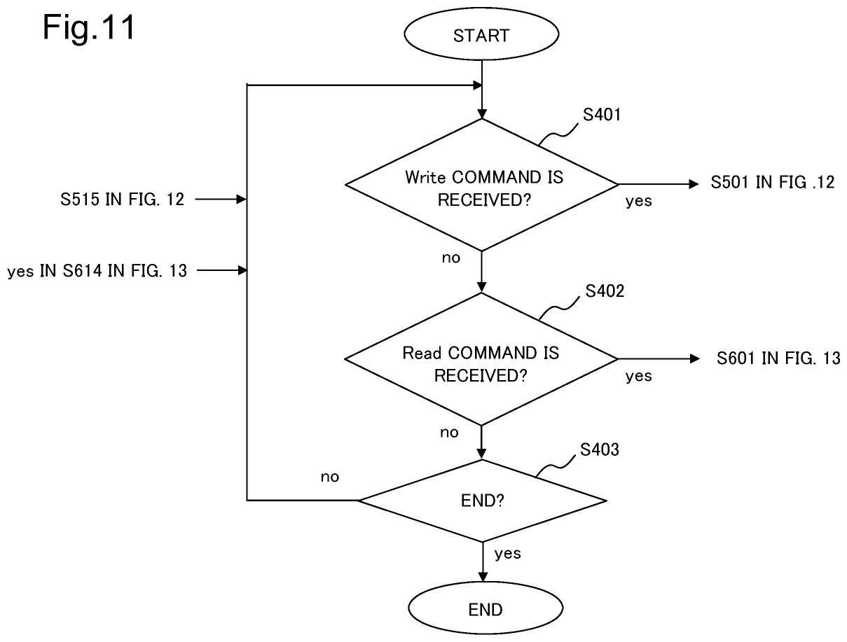

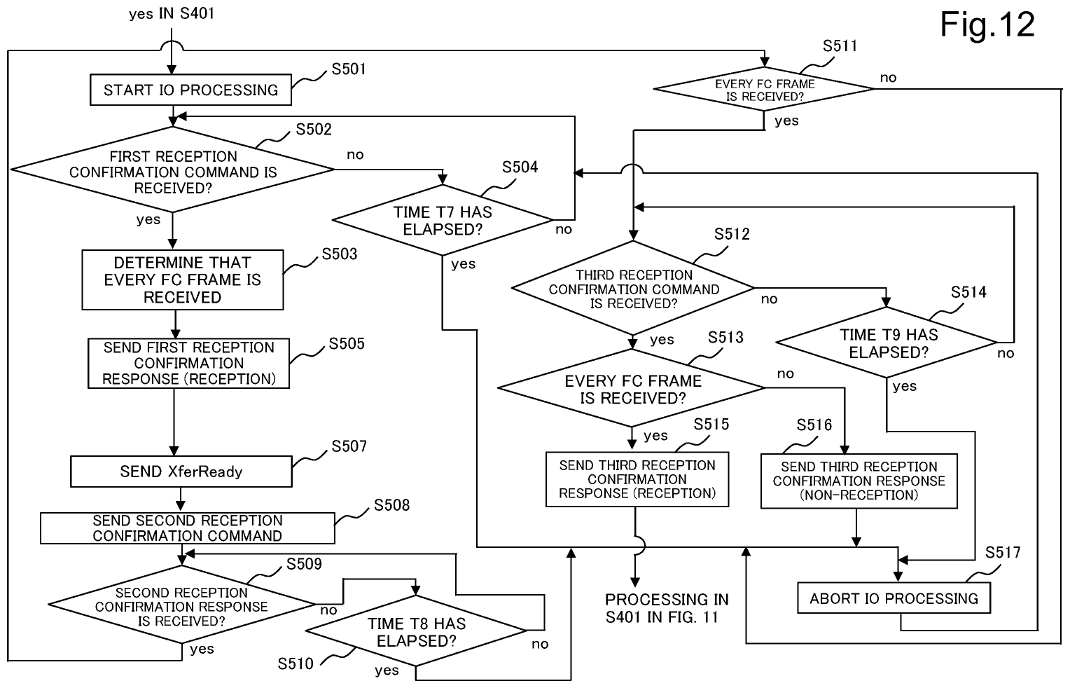

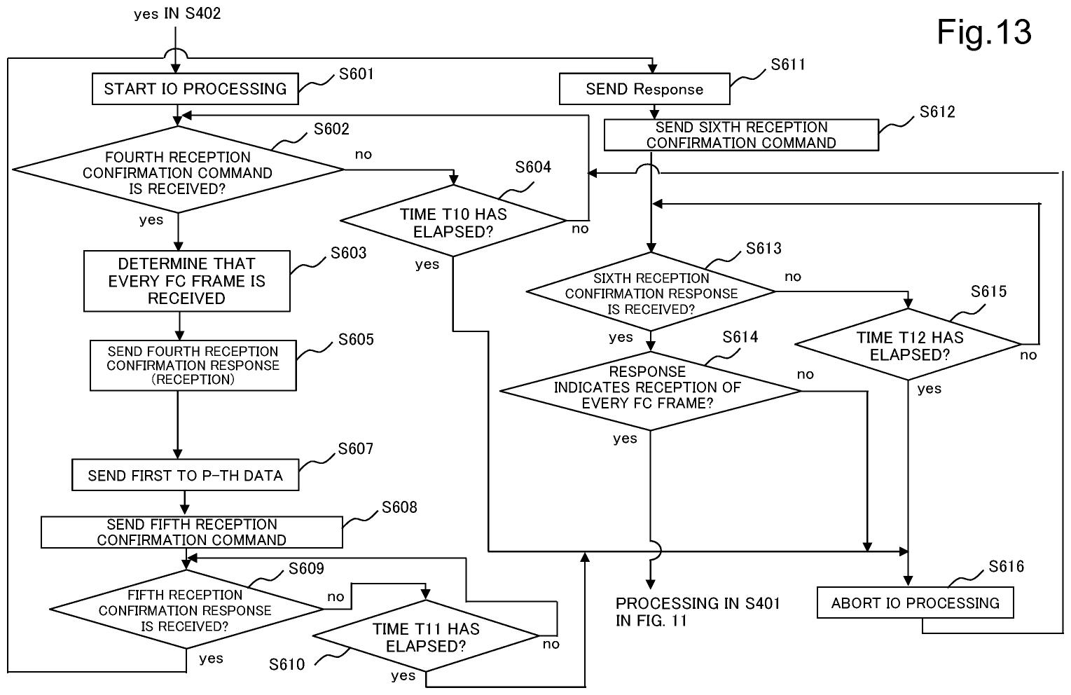

FIG. 11 to FIG. 13 are conceptual diagrams illustrating a processing flow example of processing performed by the IO processing unit 212 in the storage device 210 illustrated in FIG. 1.

For example, the IO processing unit 212 starts the processing illustrated in FIG. 11 in response to external input of start information.

Then, the IO processing unit 212 makes a determination about whether a Write command is received from the IO processing unit 112.

When the determination result by the processing in S401 is yes, the IO processing unit 212 performs processing in S501 described in FIG. 12.

On the other hand, when the determination result by the processing in S401 is no, the IO processing unit 212 performs processing in S402.

When performing the processing in S402, the IO processing unit 212 makes a determination about whether a Read command is received from the IO processing unit 112, as the processing.

When the determination result by the processing in S402 is yes, the IO processing unit 212 performs processing in S601 described in FIG. 13.

On the other hand, when the determination result by the processing in S402 is no, the IO processing unit 212 performs processing in S403.

When performing the processing in S403, the IO processing unit 212 makes a determination about whether to end the processing illustrated in FIG. 11 to FIG. 13, as the processing. For example, the IO processing unit 212 makes the determination by determining whether external input of end information exists.

When the determination result by the processing in S403 is yes, the IO processing unit 212 ends the processing illustrated in FIG. 11 to FIG. 13.

When performing the processing in S501 described in FIG. 12, the IO processing unit 212 starts IO processing related to an IOID included in the Write command reception of which being determined by the processing in S401 described in FIG. 11, as the processing.

Then, as processing in S502, the IO processing unit 212 makes a determination about whether a first reception confirmation command including the IOID related to the IP processing started by the processing in S501 is received. The first reception confirmation command includes the IOID and identification information of the Write command.

When the determination result by the processing in S502 is yes, the IO processing unit 212 performs processing in S503.

On the other hand, when the determination result by the processing in S502 is no, the IO processing unit 212 performs processing in S504.

When performing the processing in S504, the IO processing unit 212 makes a determination about whether a time T7 has elapsed after the most recent processing in S501 is ended, as the processing. The time T7 is a predetermined time for indicating an upper limit of a time in which the most recent processing in S502 is repeated.

The time T7 is a remarkably short time (for example, of the order of several hundreds of milliseconds) compared with the aforementioned waiting time for timeout (of the order of several tens of seconds).

When the determination result by the processing in S504 is yes, the IO processing unit 212 performs processing in S517.

On the other hand, when the determination result by the processing in S504 is no, the IO processing unit 212 performs the processing in S502 again.

When performing the processing in S503, the IO processing unit 212 determines that every FC frame related to the identification information included in the first reception confirmation command reception of which being determined by the processing in S502 is received, as the processing. The reason is that the identification information included in the first reception confirmation command is the identification information of the Write command. Then, the Write command is determined to be received by the most recent processing in S401 described in FIG. 11. The processing in S503 corresponds to the operation in A113 described in FIG. 4.

Then, as processing in S505, the IO processing unit 212 sends, to the IO processing unit 112, a first reception confirmation response indicating that every FC frame included in the first reception confirmation command reception of which being determined by the processing in S502 is received. The processing in S505 corresponds to the operation in A114 described in FIG. 4.

Then, as processing in S507, the IO processing unit 212 sends XferReady to the IO processing unit 112. The processing in S507 corresponds to the operation in A115 described in FIG. 4.

Then, as processing in S508, the IO processing unit 212 sends a second reception confirmation command to the IO processing unit 112. The second reception confirmation command includes the IOID related to the IO processing started by the most recent processing in S501 and identification information indicating XferReady.

Then, as processing in S509, the IO processing unit 212 makes a determination about whether a second reception confirmation response being a response to the second reception confirmation command sent by the processing in S508 is received.

When the determination result by the processing in S509 is yes, the IO processing unit 212 performs processing in S511.

On the other hand, when the determination result by the processing in S509 is no, the IO processing unit 212 performs processing in S510.

When performing the processing in S510, the IO processing unit 212 makes a determination about whether a time T8 has elapsed after the most recent processing in S508 is ended, as the processing. The time T8 is a predetermined time for indicating an upper limit of a time in which the processing in S509 is repeated.

The time T8 is a remarkably short time (for example, of the order of several hundreds of milliseconds) compared with the aforementioned waiting time for timeout (of the order of several tens of seconds).

When the determination result by the processing in S510 is yes, the IO processing unit 212 performs the processing in S517.

On the other hand, when the determination result by the processing in S510 is no, the IO processing unit 212 performs the processing in S509 again.

When performing the processing in S511, the IO processing unit 212 makes a determination about whether the second reception confirmation response indicates that every FC frame related to the identification information included in the second reception confirmation command sent by the processing in S508 is received, as the processing.

When the determination result by the processing in S511 is yes, the IO processing unit 212 performs processing in S512.

On the other hand, when the determination result by the processing in S511 is no, the IO processing unit 212 performs the processing in S517.

When performing the processing in S512, the IO processing unit 212 makes a determination about whether a third reception confirmation command including the IOID related to the IO processing started by the most recent processing in S501 is received, as the processing. The third reception confirmation command includes identification information of first to N-th data.

When the determination result by the processing in S512 is yes, the IO processing unit 212 performs processing in S513.

On the other hand, when the determination result by the processing in S512 is no, the IO processing unit 212 performs processing in S514.

When performing the processing in S514, the IO processing unit 212 makes a determination about whether a time T9 has elapsed after yes is determined in the most recent processing in S512, as the processing. The time T9 is a predetermined time for indicating an upper limit of a time in which the processing in S512 is repeated.

The time T9 is a remarkably short time (for example, of the order of several hundreds of milliseconds) compared with the aforementioned waiting time for timeout (of the order of several tens of seconds).

When the determination result by the processing in S514 is yes, the IO processing unit 212 performs the processing in S517.

On the other hand, when the determination result by the processing in S514 is no, the IO processing unit 212 performs the processing in S512 again.

When performing the processing in S513, the IO processing unit 212 makes a determination about whether every FC frame related to the identification information included in the third reception confirmation command reception of which being determined by the processing in S512 is received, as the processing. The identification information included in the second reception confirmation command is the identification information of the first to N-th data. Accordingly, the determination is a determination about whether every piece of the first to N-th data is received. The processing in S513 corresponds to the operation in A121 described in FIG. 4.

When the determination result by the processing in S513 is yes, the IO processing unit 212 performs processing in S515.

On the other hand, when the determination result by the processing in S513 is no, the IO processing unit 212 performs processing in S516.

When performing the processing in S515, the IO processing unit 212 sends, to the IO processing unit 112, a third reception confirmation response indicating that every FC frame included in the third reception confirmation command reception of which being determined by the most recent processing in S512 is received, as the processing. Then, the IO processing unit 212 performs the processing in S401 described in FIG. 11 again.

When performing the processing in S516, the IO processing unit 212 sends, to the IO processing unit 112, a third reception confirmation response indicating that one of the FC frames included in the third reception confirmation command reception of which being determined by the most recent processing in S512 is not received, as the processing. Then, the IO processing unit 212 performs the processing in S517.

When performing the processing in S517, the IO processing unit 212 aborts the IO processing started by the most recent processing in S501, as the processing. The processing in S517 includes processing corresponding to the operation in A122 described in FIG. 4.

Then, the IO processing unit 212 performs the processing in S502 again.

When performing the processing in S601 described in FIG. 13, the IO processing unit 212 starts IO processing related to an IOID included in the Read command reception of which being determined by the processing in S402 described in FIG. 11, as the processing.

Then, as processing in S602, the IO processing unit 212 makes a determination about whether a fourth reception confirmation command including the IOID related to the IP processing sent by the processing in S601 is received. The fourth reception confirmation command includes the IOIP and the identification information of the Read command.

When the determination result by the processing in S602 is yes, the IO processing unit 212 performs processing in S603.

On the other hand, when the determination result by the processing in S602 is no, the IO processing unit 212 performs processing in S604.

When performing the processing in S604, the IO processing unit 212 makes a determination about whether a time T10 has elapsed after the most recent processing in S601 is ended, as the processing. The time T10 is a predetermined time for indicating an upper limit of a time in which the processing in S602 is repeated.

The time T10 is a remarkably short time (for example, of the order of several hundreds of milliseconds) compared with the aforementioned waiting time for timeout (of the order of several tens of seconds).

When the determination result by the processing in S604 is yes, the IO processing unit 212 performs processing in S616.

On the other hand, when the determination result by the processing in S604 is no, the IO processing unit 212 performs the processing in S602 again.

When performing the processing in S603, the IO processing unit 212 determines that every FC frame related to the identification information included in the fourth reception confirmation command reception of which being determined by the processing in S602 is received, as the processing. The reason is that the identification information included in the fourth reception confirmation command is the identification information of the Read command. Then, the Read command is determined to be received by the most recent processing in S402 illustrated in FIG. 11. The processing in S603 corresponds to the operation in A163 described in FIG. 7.

Then, as processing in S605, the IO processing unit 212 sends, to the IO processing unit 112, a fourth reception confirmation response indicating that every FC frame included in the fourth reception confirmation command reception of which being determined by the processing in S602 is received. The processing in S605 corresponds to the operation in A164 described in FIG. 7.

Then, as processing in S607, the IO processing unit 212 sends first to P-th data to the IO processing unit 112. The processing in S607 corresponds to the operations in A165-1 to A165-P described in FIG. 7.

Then, as processing in S608, the IO processing unit 212 sends a fifth reception confirmation command to the IO processing unit 112. The fifth reception confirmation command includes the IOID related to the IO processing started by the most recent processing in S601 and identification information indicating the first to P-th data. The processing in S608 corresponds to the operation in A166 described in FIG. 7.

Then, as processing in S609, the IO processing unit 212 makes a determination about whether a fifth reception confirmation response being a response to the fifth reception confirmation command sent by the processing in S608 is received.

When the determination result by the processing in S609 is yes, the IO processing unit 212 performs processing in S611.

On the other hand, when the determination result by the processing in S609 is no, the IO processing unit 212 performs processing in S610.

When performing the processing in S610, the IO processing unit 212 makes a determination about whether a time T11 has elapsed after the most recent processing in S608 is ended, as the processing. The time T11 is a predetermined time for indicating an upper limit of a time in which the processing in S609 is repeated.

The time T11 is a remarkably short time (for example, of the order of several hundreds of milliseconds) compared with the aforementioned waiting time for timeout (of the order of several tens of seconds).

When the determination result by the processing in S610 is yes, the IO processing unit 212 performs the processing in S616.

On the other hand, when the determination result by the processing in S610 is no, the IO processing unit 212 performs the processing in S609 again.

When performing the processing in S611, the IO processing unit 212 sends Response to the IO processing unit 112, as the processing. The processing in S611 corresponds to the operation in A169 described in FIG. 7.

Then, as processing in S612, the IO processing unit 212 sends a sixth reception confirmation command to the IO processing unit 112. The processing in S612 corresponds to the operation in A170 described in FIG. 7.

Then, as processing in S613, the IO processing unit 212 makes a determination about whether a sixth reception confirmation response being a response to the sixth reception confirmation command sent by the processing in S612 is received.

When the determination result by the processing in S613 is yes, the IO processing unit 212 performs processing in S614.

On the other hand, when the determination result by the processing in S613 is no, the IO processing unit 212 performs processing in S615.

When performing the processing in S615, the IO processing unit 212 makes a determination about whether a time T12 has elapsed after the most recent processing in S612 is ended, as the processing. The time T12 is a predetermined time for indicating an upper limit of a time in which the processing in S613 is repeated.

The time T12 is a remarkably short time (for example, of the order of several hundreds of milliseconds) compared with the aforementioned waiting time for timeout (of the order of several tens of seconds).

When the determination result by the processing in S615 is yes, the IO processing unit 212 performs the processing in S616.

On the other hand, when the determination result by the processing in S615 is no, the IO processing unit 212 performs the processing in S613 again.

When performing the processing in S614, the IO processing unit 212 makes a determination about whether every FC frame related to the identification information included in the sixth reception confirmation command reception of which being determined by the processing in S613 is received, as the processing. The identification information included in the sixth reception confirmation command is identification information of Response. Accordingly, the determination is a determination about whether Response is received.

When the determination result by the processing in S614 is yes, the IO processing unit 212 performs the processing in S401 described in FIG. 11 again.

On the other hand, when the determination result by the processing in S614 is no, the IO processing unit 212 performs the processing in S616.

When performing the processing in S616, the IO processing unit 212 aborts the IO processing started by the most recent processing in S601, as the processing. The processing in S616 includes processing corresponding to the operation in A174 described in FIG. 7.

Then, the IO processing unit 212 performs the processing in S602 again.

Each of the IO processing unit 112 and the IO processing unit 212 (each IO processing unit) does not need to transmit a reception confirmation command for every FC frame transmitted over the FC line toward the counterpart.

For example, each IO processing unit may transmit a reception confirmation command only when data (a data group) are transmitted over the FC line. Since data (a data group) include a large number of frames, it is highly likely that part of the data is lost in the FC line. Performing reception confirmation on data (a data group) being highly likely to be lost in the FC line by use of a reception confirmation command has a significant effect in terms of shortening of the waiting time for timeout.

Furthermore, each IO processing unit may send a reception confirmation command to the counterpart after sending an FC frame group including at least any one of a Write command, a Read command, XferReady, Response, and data (a data group). In that case, the reception confirmation command includes identification information indicating the FC frame group.

The above description describes an example of a case in which, when sending a predetermined FC frame or FC frame group, the transmission side of a frame sends a reception confirmation command to the reception side immediately after the sending. However, a reception confirmation command does not need to be sent immediately after the sending. For example, the transmission side may send the reception confirmation command to the reception side only when information to be received next is not received when a predetermined time Ta elapses after the sending. For example, the time Ta in that case may be the mean value of the time between the sending and reception of information to be received next.

### Effects

The storage system according to the present example embodiment performs reception confirmation on sent information sending of which being performed between the server 110 and the storage device through the FC line, by use of a reception confirmation command and a reception confirmation response being a response to the reception confirmation command. Then, in a case of the reception confirmation response indicating that at least part of the information is not received, or the like, the transmission side promptly aborts IO processing related to transmission and reception of the information and re-executes equivalent IO processing.

Consequently, the storage system enables reduction of a waiting time required for timeout of IO processing and reduction of a delay in the IO processing, the above issues being described in the Technical Problem section. Second Example Embodiment

A second example embodiment is an example embodiment related to a storage system switching transmission and reception of information through an FC line between the method described in the Background Art section and the method described in the first example embodiment.

### Configuration and Operation

A configuration example of a storage system according to the second example embodiment is a configuration of the storage system 401 according to the first example embodiment illustrated in FIG. 1.

A description of the storage system 401 according to the second example embodiment differs from the description of the storage system 401 according to the first example embodiment in the following point.

When launching IO processing, an IO processing unit 112 in a server 110 selects between performing the IO processing in a first mode and in a second mode.

The first mode performs an operation as described in the first example embodiment. The second mode performs a common operation as described in the Background Art section.

For example, the IO processing unit 112 makes the selection in accordance with an instruction from an unillustrated control unit in the server 110.

In that case, for example, when data (a data group) sent to a storage device 210 or read from the storage device 210 do not allow delay, the control unit causes the IO processing unit 112 to select the first mode. The delay accompanies a timeout described in the Technical Problem section. For example, such a case is a case in which second processing following the processing of storing the data (data group) into the storage device 210 or reading the data (data group) from the storage device 210 does not allow the waiting time for timeout. For example, such a case is a case in which the second processing session-times-out before the waiting time elapses.

On the other hand, when data sent to the storage device 210 or read from the storage device 210 allow delay accompanying a timeout described in the Technical Problem section, the control unit causes the IO processing unit 112 to select the second mode.

The IO processing unit 112 includes specification information for specifying the first mode or the second mode in a Write command and a Read command sent to the IO processing unit 212.

The specification information may be a storage location (such as an address range) of data in a storage unit 214 in the storage device 210 illustrated in FIG. 1. In that case, separation of ranges of a storage location of data related to the first mode and a storage location of data related to the second mode in the storage unit 214 is predetermined as a rule in the storage system 401. Then, the IO processing unit 112 specifies either one of the separated storage locations in the storage unit 214, in a Write command and a Read command that are described in the first example embodiment.

On the other hand, the IO processing unit 212 in the storage device 210 determines whether to perform IO processing in the first mode or IO processing in the second mode according to the specification information included in a Write command or a Read command.

Then, based on the determination result, the storage device 210 performs IO processing in either one of the first mode and the second mode.

### Processing Flow

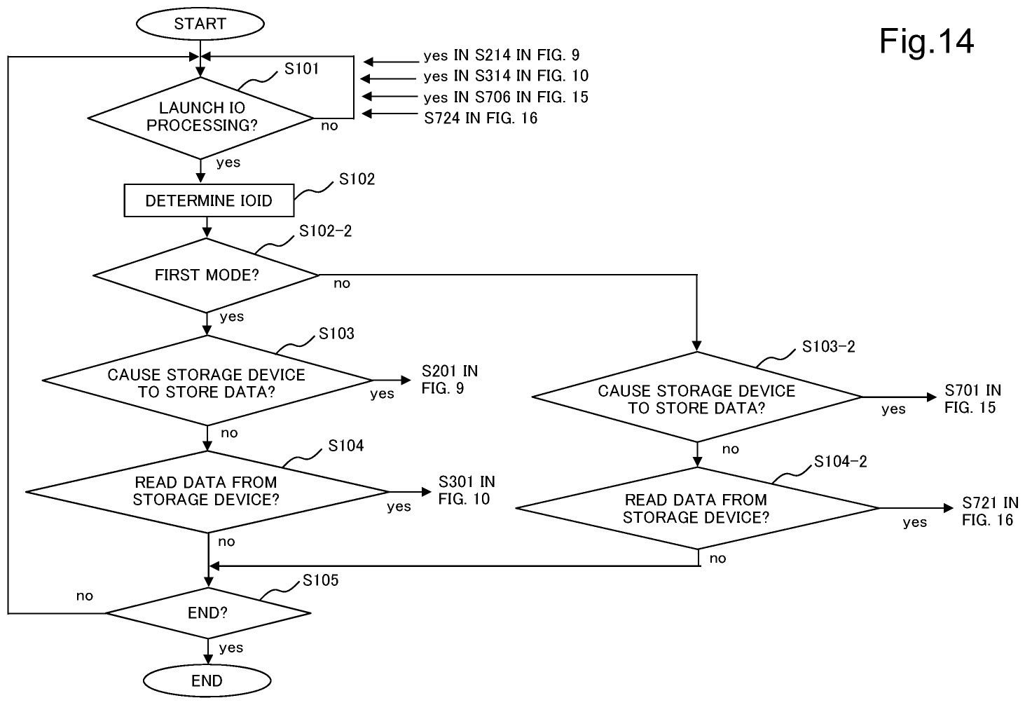

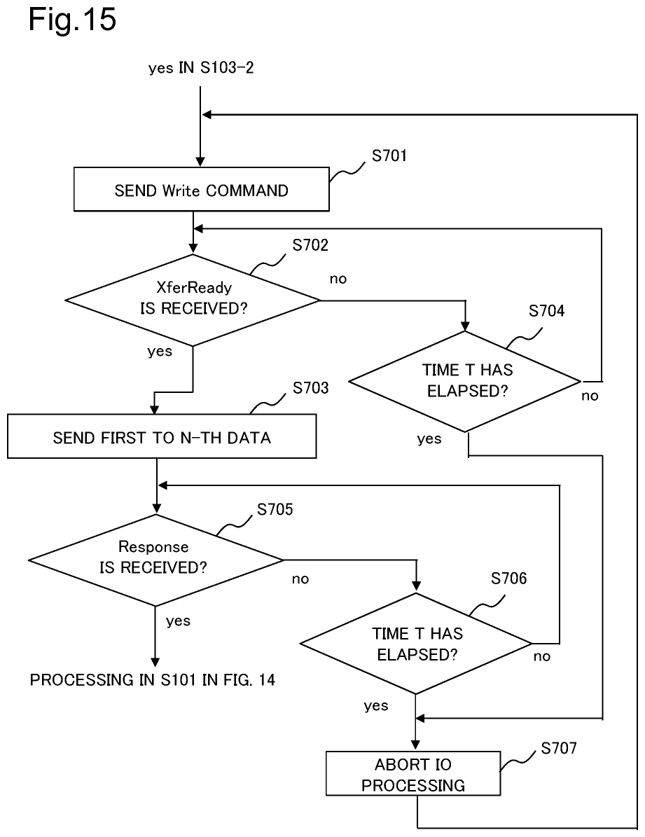

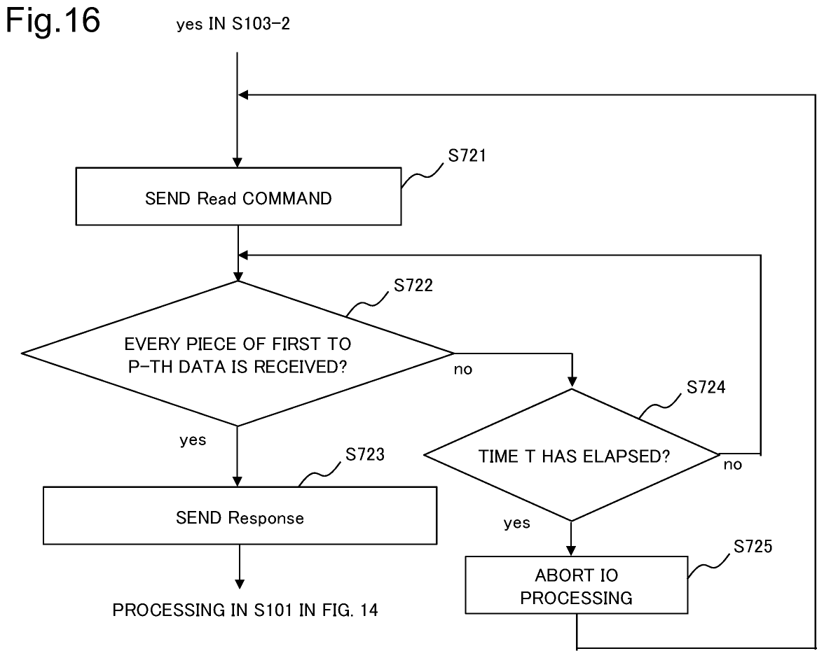

FIG. 14 is a conceptual diagram illustrating a processing flow example of processing performed by the IO processing unit 112 included in the server 110 in the storage system 401 according to the second example embodiment.

For example, the IO processing unit 112 starts the processing illustrated in FIG. 14 in response to input of start information from the aforementioned control unit.

Then, as processing in S101, the IO processing unit 112 makes a determination about whether to launch predetermined IO processing. For example, the IO processing unit 112 makes the determination in accordance with instruction information input from the control unit.

When the determination result by the processing in S101 is yes, the IO processing unit 112 performs processing in S102.

On the other hand, when the determination result by the processing in S101 is no, the IO processing unit 112 performs the processing in S101 again.

When performing the processing in S102, the IO processing unit 112 determines an IOID related to the IO processing to be launched, as the processing.

Then, as processing in S102-2, the IO processing unit 112 makes a determination about whether a mode related to the IO processing to be launched is the aforementioned first mode. For example, the IO processing unit 112 makes the determination in accordance with instruction information from the control unit.

When the determination result by the processing in S102-2 is yes, the IO processing unit 112 performs processing in S103.

On the other hand, when the determination result by the processing in S102-2 is no, the IO processing unit 112 performs processing in S103-2.

When performing the processing in S103, the IO processing unit 112 makes a determination about whether the IO processing the IOID of which being determined by the processing in S102 causes the storage device 210 to store data, as the processing. For example, the IO processing unit 112 makes the determination in accordance with instruction information input from the control unit.

When the determination result by the processing in S103 is yes, the IO processing unit 112 performs the processing in S201 described in FIG. 9.

On the other hand, when the determination result by the processing in S103 is no, the IO processing unit 112 performs processing in S104.

When performing the processing in S104, the IO processing unit 112 makes a determination about whether the IO processing the IOID of which being determined by the processing in S102 reads data from the storage device 210, as the processing. For example, the IO processing unit 112 makes the determination in accordance with instruction information input from the control unit.

When the determination result by the processing in S104 is yes, the IO processing unit 112 performs the processing in S301 described in FIG. 10.

On the other hand, when the determination result by the processing in S104 is no, the IO processing unit 112 performs processing in S105.

When performing the processing in S103-2, the IO processing unit 112 makes a determination about whether the IO processing the IOID of which being determined by the processing in S102 causes the storage device 210 to store data, as the processing. For example, the IO processing unit 112 makes the determination in accordance with instruction information input from the control unit.

When the determination result by the processing in S103-2 is yes, the IO processing unit 112 performs processing in S701 described in FIG. 15.

On the other hand, when the determination result by the processing in S103-2 is no, the IO processing unit 112 performs processing in S104-2.

When performing the processing in S104-2, the IO processing unit 112 makes a determination about whether the IO processing the IOID of which being determined by the processing in S102 reads data from the storage device 210, as the processing. For example, the IO processing unit 112 makes the determination in accordance with instruction information input from the control unit.

When the determination result by the processing in S104-2 is yes, the IO processing unit 112 performs processing in S721 described in FIG. 16.

On the other hand, when the determination result by the processing in S104-2 is no, the IO processing unit 112 performs processing in S105.

When performing the processing in S105, the IO processing unit 112 makes a determination about whether to end the processing illustrated in FIG. 14, FIG. 9, FIG. 10, FIG. 15, and FIG. 16, as the processing. For example, the IO processing unit 112 makes the determination by determining whether external input of end information exists.

When the determination result by the processing in S105 is yes, the IO processing unit 112 ends the processing illustrated in FIG. 14, FIG. 9, FIG. 10, FIG. 15, and FIG. 16.

On the other hand, when the determination result by the processing in S105 is no, the IO processing unit 112 performs the processing in S101 again.

A description of the processing illustrated in FIG. 9 is as described in the first example embodiment. However, when the determination result by the processing in S214 is yes, the IO processing unit 112 performs the processing in S101 described in FIG. 14 in place of the processing in S101 described in FIG. 8.

A description of the processing illustrated in FIG. 10 is as described in the first example embodiment. However, subsequently to the processing in S314, the IO processing unit 112 performs the processing in S101 described in FIG. 14 in place of the processing in S101 described in FIG. 8.

FIG. 15 is a conceptual diagram illustrating a processing flow example of common data storage processing based on the FC standard performed by the IO processing unit 112, the processing being described in the Background Art section.

When the determination result by the processing in S103-2 described in FIG. 14 is yes, as processing in S701, the IO processing unit 112 sends a Write command to the IO processing unit 212.

Then, as processing in S702, the IO processing unit 112 makes a determination about whether XferReady sent by the IO processing unit 212 is received.

When the determination result by the processing in S702 is yes, the IO processing unit 112 performs processing in S703.

On the other hand, when the determination result by the processing in S702 is no, the IO processing unit 112 performs processing in S704.

When performing the processing in S704, the IO processing unit 112 makes a determination about whether a time T has elapsed after the determination result of yes in the most recent processing in S101 described in FIG. 14 is derived, as the processing. The time T is a timeout time in common IO processing based on FC. The time T is of the order of several tens of seconds. It is assumed that the IO processing unit 112 can use an unillustrated timer.

When the determination result by the processing in S704 is yes, the IO processing unit 112 performs processing in S707.

On the other hand, when the determination result by the processing in S704 is no, the IO processing unit 112 performs the processing in S702 again.

When performing the processing in S703, the IO processing unit 112 sends first to N-th data to the IO processing unit 212, as the processing.

Then, as processing in S705, the IO processing unit 112 makes a determination about whether Response is received.

When the determination result by the processing in S705 is yes, the IO processing unit 112 performs the processing in S101 described in FIG. 14.

On the other hand, when the determination result by the processing in S705 is no, the IO processing unit 112 performs processing in S706.

When performing the processing in S706, the IO processing unit 112 makes a determination about whether the aforementioned time T has elapsed after the determination result of yes in the most recent processing in S101 described in FIG. 14 is derived, as the processing.

When the determination result by the processing in S706 is yes, the IO processing unit 112 performs the processing in S707.

On the other hand, when the determination result by the processing in S706 is no, the IO processing unit 112 performs the processing in S705 again.

When performing the processing in S707, the IO processing unit 112 aborts the IO processing related to the IOID specified by the processing in S102 described in FIG. 14, as the processing.

FIG. 16 is a conceptual diagram illustrating a processing flow example of common data reception processing based on the FC standard performed by the IO processing unit 112, the processing being described in the Background Art section.

When the determination result by the processing in S104-2 illustrated in FIG. 14 is yes, as processing in S721, the IO processing unit 112 sends a Read command to the IO processing unit 212.

Then, as processing in S722, the IO processing unit 112 makes a determination about whether first to P-th data (P being equal to or more than 1) sent by the IO processing unit 212 are received.

When the determination result by the processing in S722 is yes, the IO processing unit 112 performs processing in S723.

On the other hand, when the determination result by the processing in S722 is no, the IO processing unit 112 performs processing in S724.

When performing the processing in S724, the IO processing unit 112 makes a determination about whether the aforementioned time T has elapsed after the determination result of yes in the most recent processing in S101 described in FIG. 14 is derived, as the processing.

When the determination result by the processing in S724 is yes, the IO processing unit 112 performs processing in S725.

On the other hand, when the determination result by the processing in S724 is no, the IO processing unit 112 performs the processing in S722 again.

When performing the processing in S723, the IO processing unit 112 sends Response to the IO processing unit 212, as the processing.

Then, the IO processing unit 112 performs the processing in S101 described in FIG. 14 again.

When performing the processing in S725, the IO processing unit 112 aborts the IO processing related to the IOID specified by the processing in S102 described in FIG. 14, as the processing.

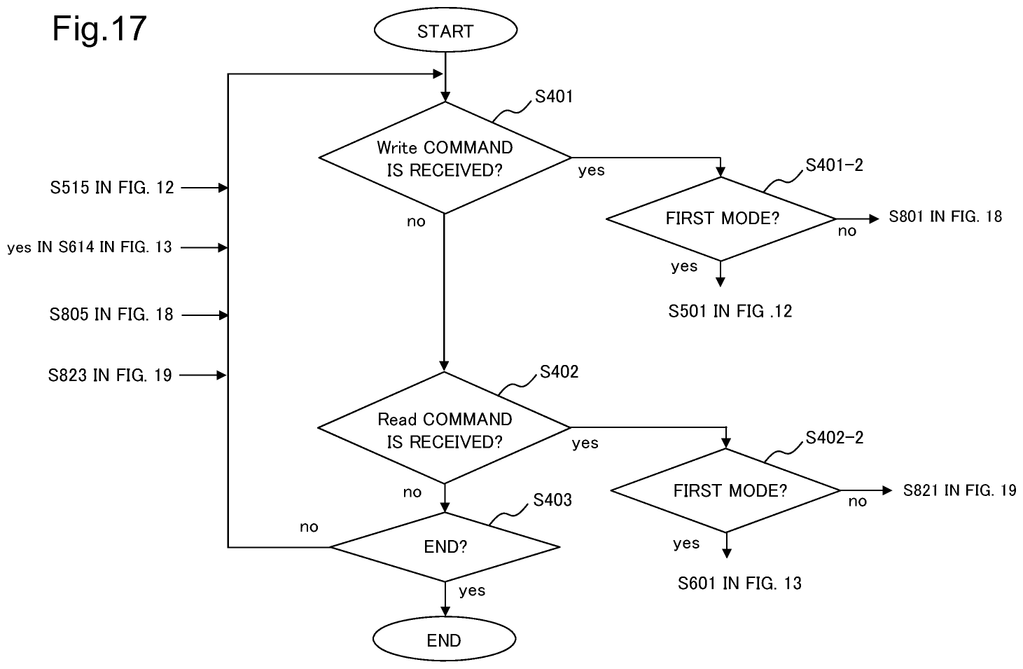

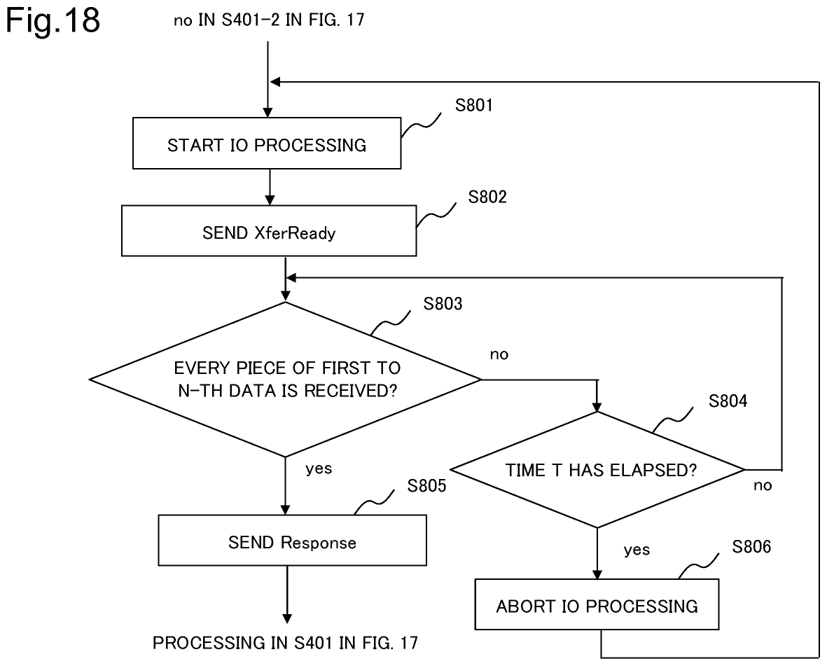

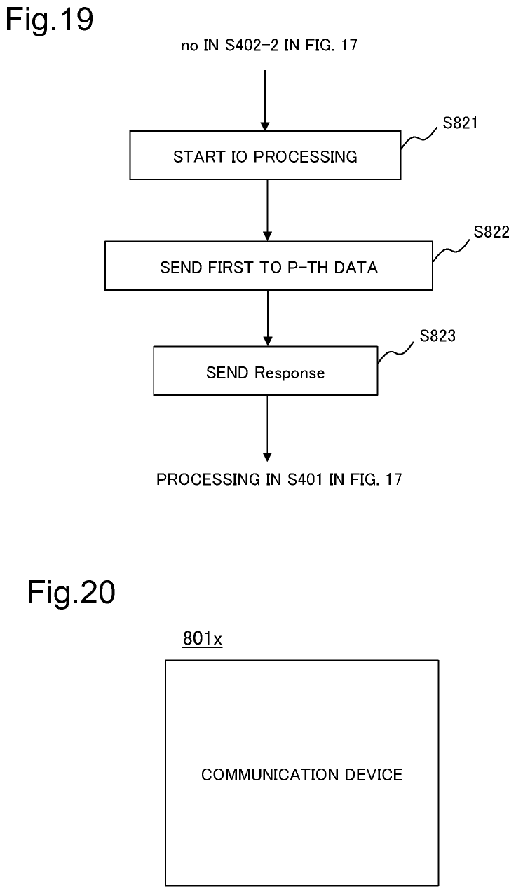

FIG. 17 is a conceptual diagram illustrating a processing flow example of processing related to IO processing performed by the IO processing unit 212 in the storage device 210 illustrated in FIG. 1.

For example, the IO processing unit 212 starts the processing illustrated in FIG. 17 in response to input of start information from the aforementioned control unit.

Then, as processing in S401, the IO processing unit 212 makes a determination about whether a Write command is received from the IO processing unit 112.

When the determination result by the processing in S401 is no, the IO processing unit 212 performs processing in S402.

On the other hand, when the determination result by the processing in S401 is yes, the IO processing unit 212 performs processing in S401-2.

When performing the processing in S401-2, the IO processing unit 212 makes a determination about whether the aforementioned specification information included in the Write command reception of which being determined by the processing in S401 specifies the first mode, as the processing.

When the determination result by the processing in S401-2 is yes, the IO processing unit 212 performs the processing in S501 described in FIG. 12.

On the other hand, when the determination result by the processing in S401-2 is no, the IO processing unit 212 performs processing in S801 described in FIG. 18.

When performing the processing in S402, the IO processing unit 212 makes a determination about whether a Read command is received from the IO processing unit 112, as the processing.

When the determination result by the processing in S402 is no, the IO processing unit 212 performs processing in S403.

On the other hand, when the determination result by the processing in S402 is yes, the IO processing unit 212 performs processing in S402-2.

When performing the processing in S402-2, the IO processing unit 212 makes a determination about whether the aforementioned specification information included in the Read command reception of which being determined by the processing in S402 specifies the first mode, as the processing.

When the determination result by the processing in S402-2 is yes, the IO processing unit 212 performs the processing in S601 described in FIG. 13.

On the other hand, when the determination result by the processing in S402-2 is no, the IO processing unit 212 performs processing in S821 described in FIG. 19.

A description of the processing in FIG. 12 performed by the IO processing unit 212 when the determination result of yes is derived by the processing in S401-2 described in FIG. 17 is as described in the first example embodiment. However, subsequently to the processing in S515 described in FIG. 12, the processing in S401 described in FIG. 17 is performed in place of S401 described in FIG. 11.

A description of the processing in FIG. 13 performed by the IO processing unit 212 when the determination result of yes is derived by the processing in S402-2 described in FIG. 17 is as described in the first example embodiment. However, when the determination result by the processing in S614 described in FIG. 13 is yes, the processing in S401 described in FIG. 17 is performed in place of S401 in FIG. 11.

FIG. 18 is a conceptual diagram illustrating a processing flow example of processing related to common data storage based on the FC standard performed by the IO processing unit 112, the processing being described in the Background Art section.

When the determination result by the processing in S401-2 described in FIG. 17 is no, as processing in S801, the IO processing unit 212 starts IO processing related to an IOID included in the Write command sent by the IO processing unit 112.

Then, as processing in S802, the IO processing unit 212 sends XferReady to the IO processing unit 112.

Then, as processing in S803, the IO processing unit 212 makes a determination about whether every piece of first to N-th data is received.

When the determination result by the processing in S803 is yes, the IO processing unit 212 performs processing in S805.

On the other hand, when the determination result by the processing in S803 is no, the IO processing unit 212 performs processing in S804.

When performing the processing in S804, the IO processing unit 212 makes a determination about whether the aforementioned time T has elapsed after the determination result of yes in the most recent processing in S401 described in FIG. 17 is derived, as the processing.

When the determination result by the processing in S804 is yes, the IO processing unit 212 performs processing in S806.

On the other hand, when the determination result by the processing in S804 is no, the IO processing unit 212 performs the processing in S803 again.

When performing the processing in S805, the IO processing unit 212 sends Response to the IO processing unit 112, as the processing. Then, the IO processing unit 212 performs the processing in S401 described in FIG. 17.

When performing the processing in S806, the IO processing unit 212 aborts the IO processing started by the processing in S801, as the processing. Then, the IO processing unit 212 performs the processing in S801 again.

FIG. 19 is a conceptual diagram illustrating a processing flow example of common data reading processing based on the FC standard performed by the IO processing unit 112, the processing being described in the Background Art section.

When the determination result by the processing in S402-2 described in FIG. 17 is yes, as processing in S821, the IO processing unit 212 starts IO processing related to an IOID included in a Write command reception of which being determined by the processing in S401 described in FIG. 17.

Then, as processing in S822, the IO processing unit 212 sends first to P-th data to the IO processing unit 112.

Then, as processing in S823, the IO processing unit 212 sends Response to the IO processing unit 112.

Then, the IO processing unit 212 performs the processing in S401 described in FIG. 17.

### Effects

The storage system according to the second example embodiment performs reception confirmation only on data for which IO processing delay is determined to be avoided, the reception confirmation being related to transmission and reception of information through the FC line and being described in the first example embodiment. Consequently, the storage system enables reduction in an IO processing delay for data an IO processing delay of which being required to be reduced. Then, the storage system performs common IO processing performed over the FC line on data an IO processing delay of which not being required to be reduced.

In the IO processing described in the first example embodiment, a reception confirmation command and a reception confirmation response responding to the command are transmitted over the FC line with respect to a frame sent through the FC line. Consequently, in the IO processing described in the first example embodiment, the number of frames passing through the FC line increases compared with the common IO processing.

When the number of frames passing through the FC line excessively increases, there is a risk of occurrence of IO processing delay caused by the increase.

The communication system may reduce a risk of occurrence of IO processing delay due to increase in the number of frames passing through the FC line.

FIG. 20 is a conceptual diagram illustrating a configuration of a communication device 801x being a minimum configuration of the communication devices according to the example embodiments.

The communication device 801x may receive identification information assigned to an information group transmitted by a source, from the source through a Fibre Channel line. At that time, after the reception, the communication device 801x may determine that at least part of the information group is not received, based on the identification information. In that case, the communication device 801x issues predetermined transmission information to the source through the Fibre Channel line.

The source and the communication device 801x perform reception confirmation on sending of the information group, by transmission and reception of the identification information and the transmission information thereof. Consequently, when receiving the transmission information, the source can determine loss of part of the sent information without awaiting a waiting time required for timeout of IO processing. Then, the IO processing related to transmission and reception of the information can be promptly aborted, and re-execution of equivalent IO processing can be performed.

Consequently, the communication device 801x can eliminate a waiting time required for timeout of IO processing, the waiting time being described in the Technical Problem section, and reduce a delay in the IO processing.

Consequently, with the configuration, the communication device 801x provides the effect described in the Advantageous Effects of Invention section.

For example, the communication device 801x illustrated in FIG. 20 is a device including the IO processing unit 112 illustrated in FIG. 1 or a device including the IO processing unit 212. For example, the Fibre Channel line is the FC line 301 illustrated in FIG. 1. For example, the information group includes one or more of a Write command, a Read command, XferReady, Response, first to N-th data, and first to P-th data that are described in the example embodiments. For example, the identification information is the identification information described in the example embodiments. For example, the sent information includes first to sixth reception confirmation responses described in the example embodiments.

While the example embodiments of the present invention have been described above, the present invention is not limited to the aforementioned example embodiments, and further modification, substitution, and/or adjustment can be made within the basic technological concept of the present invention. For example, the configurations of components illustrated in the drawings are examples for assisting understanding of the present invention and are not limited to the configurations illustrated in the drawings.

The whole or part of the example embodiments disclosed above can be described as, but not limited to, the following supplementary notes.

### Supplementary Note 1

A communication device

issuing predetermined transmission information to a source through a Fibre Channel line when determining that at least part of an information group transmitted by the source is not received, based on identification information assigned to the information group, after receiving the identification information from the source through the Fibre Channel line.

### Supplementary Note 2

The communication device according to Supplementary Note 1, wherein

the transmission information is a first response to the identification information.

### Supplementary Note 3

The communication device according to Supplementary Note 1 or 2, wherein

the transmission information includes information indicating the non-reception.

### Supplementary Note 4

The communication device according to any one of Supplementary Notes 1 to 3, wherein,

when reception is determined for the every information group, the issuance of second transmission information is performed.

### Supplementary Note 5

The communication device according to Supplementary Note 4, wherein

the second transmission information is a second response to the identification information.

### Supplementary Note 6

The communication device according to Supplementary Note 4 or 5, wherein

the second transmission information includes information indicating the reception.

### Supplementary Note 7

The communication device according to any one of Supplementary Notes 1 to 5, wherein

the issuance may not be executed.

### Supplementary Note 8

The communication device according to any one of Supplementary Notes 1 to 7, wherein

the information group is a data frame group including one or more data frames.

### Supplementary Note 9

The communication device according to any one of Supplementary Notes 1 to 8, wherein

the information group is any one of a Write command, a Read command, XferReady, and Response that are based on a Fibre Channel standard.

### Supplementary Note 10

The communication device according to any one of Supplementary Notes 1 to 9, wherein

the information group includes a data group including input-output processing target data.

### Supplementary Note 11

The communication device according to any one of Supplementary Notes 1 to 9, wherein

the information group includes at least any one of a Write command, a Read command, XferReady, and Response that are based on a Fibre Channel standard.

### Supplementary Note 12

The communication device according to any one of Supplementary Notes 1 to 11, wherein

the communication device is included in a server.

### Supplementary Note 13

The communication device according to any one of Supplementary Notes 1 to 11, wherein

the communication device is included in a storage device.

### Supplementary Note 14

A communication system including:

the communication device according to any one of Supplementary Notes 1 to 13; and

the source.

### Supplementary Note 15

The communication system according to Supplementary Note 14, wherein

the communication device and the source mutually perform input-output processing related to predetermined data through the Fibre Channel line.

### Supplementary Note 16

The communication system according to Supplementary Note 15, wherein

a second mode being a mode related to the input-output processing in which the issuance is not performed is included.

### Supplementary Note 17

The communication system according to Supplementary Note 16, wherein

the source makes a determination about whether to be in the second mode, based on the data.

### Supplementary Note 18

The communication system according to Supplementary Note 16 or 17, wherein,

with respect to the input-output processing related to a first mode being the mode in which the issuance is performed, the source sends second identification information indicating the input-output processing and specification information indicating the first mode to the communication device.

### Supplementary Note 19

The communication system according to Supplementary Note 18, wherein the specification information is included in at least either one of a Write command and a Read command that are based on a Fibre Channel standard.

### Supplementary Note 20

The communication system according to Supplementary Note 18 or 19, wherein

the specification information is represented by area information indicating a part of the communication device, the part storing the data.

### Supplementary Note 21

The communication system according to Supplementary Note 20, wherein

the area information is indicated by an address range of a recording unit included in the communication device.

### Supplementary Note 22

The communication system according to any one of Supplementary Notes 14 to 21, wherein

the source is included in a server.

### Supplementary Note 23

The communication system according to any one of Supplementary Notes 14 to 22, wherein

the communication device is included in a storage device.

### Supplementary Note 24

A communication method including

issuing predetermined transmission information to a source through a Fibre Channel line when determining that at least part of an information group transmitted by the source is not received, based on identification information assigned to the information group, after receiving the identification information from the source through the Fibre Channel line.

### Supplementary Note 25

A communication program causing a computer to execute

processing of issuing predetermined transmission information to a source through a Fibre Channel line when determining that at least part of an information group transmitted by the source is not received, based on identification information assigned to the information group, after receiving the identification information from the source through the Fibre Channel line.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-036242, filed on Mar. 1, 2018, the disclosure of which is incorporated herein in its entirety by reference.

### REFERENCE SIGNS LIST

110 Server
112, 212 IO processing unit
113 Recording unit
210 Storage device
213 Memory
216 Control unit
214 Storage unit
301 FC line
401 Storage system
801x Communication device

What is claimed is:

1. A communication device
issuing predetermined transmission information to a source through a Fibre Channel line when determining that at least part of an information group transmitted by the source is not received, based on identification information assigned to the information group, after receiving the identification information from the source through the Fibre Channel line.

2. The communication device according to claim 1, wherein
the transmission information is a first response to the identification information.

3. The communication device according to claim 1, wherein
the transmission information includes information indicating the non-reception.

4. The communication device according to claim 1, wherein,
when reception is determined for the every information group, the issuance of second transmission information is performed.

5. The communication device according to claim 4, wherein
the second transmission information is a second response to the identification information.

6. The communication device according to claim 4, wherein
the second transmission information includes information indicating the reception.

7. The communication device according to claim 1, wherein
the issuance may not be executed.

8. The communication device according to claim 1, wherein
the information group is a data frame group including one or more data frames.

9. The communication device according to claim 1, wherein
the information group is any one of a Write command, a Read command, XferReady, and Response that are based on a Fibre Channel standard.

10. The communication device according to claim 1, wherein
the information group includes a data group including input-output processing target data.

11. The communication device according to claim 1, wherein
the information group includes at least any one of a Write command, a Read command, XferReady, and Response that are based on a Fibre Channel standard.

12. The communication device according to claim 1, wherein
the communication device is included in a server.

13. The communication device according to claim 1, wherein
the communication device is included in a storage device.

14. A communication system comprising:
the communication device according to claim 1; and
the source.

15. The communication system according to claim 14, wherein
the communication device and the source mutually perform input-output processing related to predetermined data through the Fibre Channel line.

16. The communication system according to claim 15, wherein
a second mode being a mode related to the input-output processing in which the issuance is not performed is included.

17. The communication system according to claim 16, wherein
the source makes a determination about whether to be in the second mode, based on the data.

18. The communication system according to claim 16, wherein,
with respect to the input-output processing related to a first mode being the mode in which the issuance is performed, the source sends second identification information indicating the input-output processing and specification information indicating the first mode to the communication device.

19-23. (canceled)

24. A communication method comprising
issuing predetermined transmission information to a source through a Fibre Channel line when determining that at least part of an information group transmitted by the source is not received, based on identification information assigned to the information group, after receiving the identification information from the source through the Fibre Channel line.

25. A non transitory computer readable recording medium having a communication program stored thereon, the communication program causing a computer to execute
processing of issuing predetermined transmission information to a source through a Fibre Channel line when determining that at least part of an information group transmitted by the source is not received, based on identification information assigned to the information group, after receiving the identification information from the source through the Fibre Channel line.
